(19) United States
(12) Patent Application Publication
(10) Pub. No.: US 2005/0031843 A1
(43) Pub. Date: Feb. 10, 2005

(54) Multi-layer fire barrier systems

(76) Inventors: John W. Robinson, Fernandina Beach, FL (US); Anthony M. Mazany, Amelia Island, FL (US); Craig L. Cartwright, Jacksonville, FL (US)

Correspondence Address: HUDAK, SHUNK & FARINE, CO., L.P.A., 2020 FRONT STREET, SUITE 307, CUYAHOGA FALLS, OH, 44221, US

(21) Appl. No.: 10/858,624

(22) Filed: Jun. 2, 2004

Related U.S. Application Data
(63) Continuation-in-part of application No. 10/777,885, filed on Feb. 12, 2004.
Application No. 10/777,885 is a continuation-in-part of application No. 09/871,765, filed on Jun. 1, 2001.
Application No. 10/777,885 is a continuation-in-part of application No. 09/871,998, filed on Jun. 1, 2001.
(60) Provisional application No. 60/476,671, filed on Jun. 6, 2003.
(60) Provisional application No. 60/233,952, filed on Sep. 20, 2000.
(60) Provisional application No. 60/233,985, filed on Sep. 20, 2000.

(51) Int. Cl. B27N 9/00

(52) U.S. Cl. 428/293.4; 428/921; 428/446

(57) ABSTRACT

A fire-barrier system comprises at least one alkali silicate resin composition layer and at least one layer of any of the following: an insulation layer, an intumescent layer, a foam layer, a corrugated layer, a reflective surface layer, and a reinforcing material layer. The fire-barrier system when utilize in association with a substrate such as wood, a polymer, etc. provides enhanced fire resistance performance, thermal barrier, an oxidation barrier, and the like.

### CROSS REFERENCE

This application is based on U.S. Provisional Patent Application 60/476,671, filed Jun. 6, 2003 for a Fire Resistant Barrier. This application is also a continuation-in-part of U.S. patent application Ser. No. 10/777,885, filed Feb. 12, 2004, entitled “Inorganic Matrix Compositions, Composites incorporating the Matrix, and Process of Making the Same”; which claims the benefit of U.S. patent application Ser. No. 09/871,765, filed Jun. 1, 2001, which claims the benefit of U.S. Provisional Patent Application 60/233,952, filed Sep. 20, 2000, entitled “Inorganic Matrix Compositions, Composites and Process of Making the Same”; and also U.S. patent application Ser. No. 10/777,885 claims the benefit of U.S. patent application Ser. No. 09/871,998, filed Jun. 1, 2001, which claims the benefit of U.S. Provisional Patent Application 60/233,985, filed Sep. 20, 2000, entitled Inorganic Matrix Compositions and Composites Incorporating the Matrix Composition”. All of the above applications are herby fully incorporated herein by reference.

### FIELD OF THE INVENTION

The present invention relates to improved fire-barrier systems or multi-layer systems comprising at least one inorganic polymer matrix layer derived from an alkali silicate, and one or more non-silicate network former, and/or a reactive glass, and optionally a secondary network modifier. Other layers can be any of the following: an insulation layer, an intumescent layer, a foam layer, a corrugated layer, a reflective surface layer, and reinforcing materials either as a separate layer or incorporated within any of the above layers and preferably within the inorganic polymer matrix layer. More specifically, the above layers can serve as a core, an intermediate layer, or as an outer barrier layer with regard to high heat and/or fire environments for protecting desired substrates such as wood, metal, and the like.

### BACKGROUND OF THE INVENTION

Inorganic matrices are useful as fire retardant binders for composite materials, bulk materials, adhesives, cellular materials, such as foamed materials, or composite materials. As bulk materials, they are used to form shaped objects which when cured provide a structural material. As a composite material, the matrix composition is used to impregnate a fabric, which may be combined with other similarly impregnated fabrics, to form the composite lay-up, which is then shaped and cured to form a shaped object, similar to a bulk material, but with the benefit of the reinforcement provided by the fabric.

The most familiar composite systems today are based on organic polymer matrices such as epoxy/glass fiber, epoxy/carbon fiber, polyurethane/glass fiber, PVC/glass fiber, polyimide/quartz fiber, polyester/glass fiber and nylon/glass fiber. Although organic polymer composites exhibit excellent physical and mechanical properties, they are limited with regard to flammability, smoke and gas generation and elevated service temperatures. The flammability of organic polymer-based composites can be reduced by the addition of inorganic components and/or additives. The substitution of hydrogen atoms with halogen atoms (such as for example, chlorine) in hydrocarbons and hydrocarbon polymers can significantly reduce flammability and smoke/gas generation but will degrade at temperatures greater than 250° C. and eventually incinerate at temperatures greater than 450° C. Organic thermoplastic polymers also deform at relatively low temperatures (about 100° C.-300° C.) and organic polymers designed for higher service temperatures are generally prohibitive in material and processing costs.

Other composite materials include metal matrix composites (MMC), ceramic matrix composites (CMC), carbon-carbon composites as well as other inorganic matrix composites. A composite matrix may be 100% inorganic, or it may contain some organic content. Inorganic matrix networks include ceramics, oxide based ceramics, glasses, metals, metal alloys, cementitious materials, and the like. Other materials can be considered include inorganic particles encapsulated with inorganic binders, organic resins filled with inorganic fillers, inorganic-organic hybrids such as silicone, and other inorganic matrix materials known to those knowledgeable in the arts.

Alkali silicates are employed as affordable inorganic matrix binder materials. See for example, U.S. Pat. Nos. 4,472,199; 4,509,985; 4,888,311; 5, 288,321; 5,352,427; 5,539,140; or 5,798,307 to Davidovits; U.S. Pat. No. 4,936,939 to Woolum; or U.S. Pat. No. 4,284,664 to Rauch.

Fire doors, which are one form of fire barrier, represent a multi-billion dollar market in North America alone and just as much in Europe. The market for fire doors is expected to grow with the advent of more stringent government regulations stemming from the 9/11 disaster and pressure from the insurance companies. The technology used in making a fire door is based on the rating the door needs to obtain. Performance of these fire doors is measured using a fire test that measures the time that the door can resist the fire and still retain adequate strength. The test protocols can vary but normally the Warnock-Hersey protocol is the one used in the US. This protocol consists of the E-119 fire curve with or without a hose stream at the end of the test. Thus, a door would be exposed in a furnace to a flame for a period of time, e.g., 60 minutes, and then the door is hit with a hose stream. A door that maintains its integrity will pass. Fire doors range from 20 minutes to multiple hours with the majority being 20, 45, 60 and 90 minute rated doors. The construction and materials of a 20 minute door versus a 90 minute door varies substantially which is reflected not only in the fire rating but also the cost of the door.

A 20-minute door can be as simple as a wooden or plastic door with intumescent strips on the edges to seal the door. Whereas a 60 or 90 minute door requires a core of some type in addition to the edge strips to obtain the additional time. The core serves multiple purposes depending on the door construction and materials. First, the core is a passive fire protection preventing the fire from penetrating through the door. Second, the core insulates the non-fire side to maintain a low temperature during the test. Third, the core can help in maintaining the doors structural integrity during the hose stream test after the fire exposure. Cores used in fire doors can perform all of these functions or just one or two of these functions, also the effectiveness of the cores in these three areas can vary depending on materials and construction of the door. Most 90 minutes doors are metal flat doors with a mineral core. The core in these doors function primary as an insulation with the steel functioning as the fire barrier and strength retention after the fire test to pass the hose stream. There are also a small number of panel doors (referred to style and rail doors) that have a 90-minute rating. In most cases these will have an intumescent material for the core. The core functions primarily as a fire barrier and insulation for the non-fire side of the door and to a very limited extent a structural material. The wood on the non-fire side of door functions as the main structural material to withstand the hose stream.

Examples of these prior art structures can be found in the prior art patents. For example, U.S. Pat. No. 4,270,326 to Hölter, et al. teaches a fabric of ceramic or glass fibers for use in fireproof door where the fibers are felted together by similar needlelike fibers, while U.S. Pat. No. 4,879,320 to Hastings teaches a fire retardant coating material which includes a fluid intumescent material and refractory fibers of various sizes dispersed and suspended therein. U.S. Pat. Nos. 4,756,945 and 4,936,064 to Gibb teach a fireproof panel that comprises a matrix of refractory material having a reinforcement material imbedded therein or on the surface thereof. Gibb '945 teaches a non-combustible blanket material which is made from inorganic fibers formed into a fireproof, porous cloth and a heat-expandable, non-combustible layer is affixed to one side of the substrate layer: U.S. Pat. No. 4,801,496 to Buchacher teaches a fire wall constructed of a composite of materials including a fire-protecting layer of intumescent material combined with layers of a graphite/epoxy or Kevlar®/epoxy.

Examples of cementitious materials include U.S. Pat. No. 4,159,302 to Greve, et al. that teaches a fire door that includes expanded perlite, gyppsum, set hydraulic cement, and an inorganic binder. U.S. Pat. No. 4,064,317 to Fukuba, et al. that teaches a flame resistant plasterboard. U.S. Pat. No. 6,240,691 to Holzkaemper, et al. that teaches a composite panel including a foam sheet made of a cementitious material.

U.S. Pat. Nos. 4,818,595 and 5,130,184 to Ellis teach fire barriers for use on or between wood or plastic substrates that employ paint-like slurries of alumina cements plus colloidal silica dispersions. European Patent No. EP 0 674.089 to Wood teaches a fire door made of a wood sandwich and includes a thermally insulting fire resistant material which is a mixture of fire resistant calcium aluminate cement and inorganic fibers.

Intumescent compositions can include sodium silicate compositions, which when exposed to heat tend to expand due to a build up foaming pressure and under continued exposure to heat tend to form a char which offers protection to the structure. A number of intumescent compositions are disclosed and employed in fire protection coatings, including U.S. Pat. No. 4,729,916 to Feldman; U.S. Pat. No. 5,476,891 to Welna; U.S. Pat. No. 5,786,095 to Batdorf; U.S. Pat. No. 4,675,577 to Licht; U.S. Pat. No. 5,498,466 to Navarro, et al.; and U.S. Pat. No. 5,580,648 to Castle, et al. The Castle patent teaches a mastic intumescent fire protection coating that can be applied to structural members such an I-beams. Other examples of intumescent laminate systems include U.S. Pat. No. 3,934,066 to Murch, et al.; U.S. Pat. No. 5,258,216 to vonBonin, et al.; U.S. Pat. No. 5,053,288 to Delvaux, et al.; U.S. Pat. No. 4,297,252 to Caesar, et al.; U.S. Pat. No. 6,340,389 to Klus; U.S. Pat. Nos. 6,270,915 and 6,182,470 to Turpin, et al.; U.S. Pat. No. 4,799,349 to Luckanuck, et al.; and U.S. Pat. No. 5,722,213 to Morency.

Fire-barrier or door structures have also incorporated additional structural features such as wire reinforcement, such as taught by U.S. Pat. No. 5,215,806 to Bailey; heat reflective metal layers, such as taught by U.S. Pat. No. 4,509,559 to Cheetham, et al.; and honeycomb or spacing materials such as U.S. Pat. No. 4,229,872 to Miguel, et al. or U.S. Pat. No. 4,767,656 to Chee, et al.

### SUMMARY OF THE INVENTION

Various multiple layer fire-barrier systems or multi-layer laminates are disclosed which comprise one or more layers of a fire barrier. In general, the fire barrier is an inorganic polymer matrix derived from at least an alkali silicate. The materials which comprise the one or more remaining layers generally provide one or more of the following: enhance fire resistant performance; a thermal barrier; an oxidation barrier, reinforcement, residual strength during and after a fire, burn through prevention, or smoke level reduction, and the like. The actual design of the fire barrier system is generally based upon the required performance. Thus, the various layers generally comprise one or more insulation materials, one or more intumescent materials, one or more foams, one or more corrugated materials, one or more reflective layers, etc., as well as generally one or more reinforcing materials such as fibers or sheets which can exist as a separate layer or be incorporated into one of the above layers.

The inorganic polymer matrix of the present invention can desirably be prepared either (1) as the reaction product of an alkali silicate, one or more non-silicate network formers such as an acidic oxoanionic compound and/or a reactive glass, water and optionally a filler, and one or more secondary network linking units (such as a multivalent cation(s) selected from Groups 2, 3, 4, 5, 6, 7, 8, 9, 10, 11, 12, 13, 14, 15 or 16 such as an alkaline earth salt) or (2) as the reaction product of an alkali base, a silica source, and water as well as the non-silicate network formers and network modifiers, or a combination of these. Furthermore, the modified inorganic polymer matrix can be achieved using an aqueous slurry of an alkali silicate (or its precursors), a reactive glass and water as well as gel inhibitors and other network forming materials and modifiers. The ability to vary these “building blocks” enables one to tailor product properties to suit numerous high-temperature applications. The composition can incorporate other network forming materials, modifiers and fillers.

Alkali silicate based composites can be prepared by applying an aqueous slurry of the modified alkali silicate matrix to a reinforcing medium, such as a continuous or discontinuous glass, carbon, plated carbon, oxidized carbon, polymer-coated carbon, polymer-coated glass, ceramic-coated carbon, ceraminc-coated glass, metal-coated carbon, metal-coated glass, steel, stainless steel, plated steel, polymer, minerals, or other fiber tow or mat. After an optional B-staging period and/or separation(s) intended to removed excess reactants, non-polymeric products, contaminants and/or other undesired matter the composite is cured within a temperature range of about 15° C. to about 1000° C. and higher, and at a pressure sufficient to consolidate the composite, usually at an external pressure range from ambient to about 2,000 psi and under a vacuum of about ambient to about 10⁻³ torr (e.g., vacuum bagging). The preferred range for the temperature is between 50° C. to 200° C. and at a pressure of less than about 200 or about 250 psi with or without vacuum bagging. The term “B-staging” is a common term used in composite technology to describe the practice of allowing a polymer matrix precursor to react and proceed to a partially polymerized intermediate stage short of a fully cured polymer network. Vacuum bagging can also be implemented to aid water removal and consolidation. Separation methods include water, solution and/or solvent rinsing, chemical vapor and/or gaseous infiltration. The composite can be shaped by various methods including compression molding, as well as other typical molding methods.

The resulting inorganic matrix composition and/or composite exhibit thermal stability up to about 1000° C. and higher, depending upon the formulation and processing, and possess excellent properties with respect to flame, smoke and toxicity. Furthermore, a composite made according to the present invention is lightweight with good thermal and electrical insulating characteristics.

In lieu of or in addition to the inorganic polymer matrix, other suitable inorganic fire-barrier compounds include oxide-based cements, mortars, refractory materials, and the like. Suitable oxides include those of silicon, aluminum, magnesium, and titanium, and compounds that incorporate such oxides such as silicates, aluminates, and the like. Additional oxides that can be incorporated in conjunction with those noted earlier, include sulfur, calcium, and iron. In addition, naturally occurring oxide minerals of indeterminate composition can be incorporated into the inorganic resin. The preferred inorganic resin composition is an alkali silicate resin composition.

### BRIEF DESCRIPTION OF THE DRAWINGS

The invention consists of the novel parts, construction, arrangement, combinations and improvements shown and described. The accompanying drawings that are incorporated and constitute a part of the specification illustrate one embodiment of the invention and together with the description serve to explain the principles of the invention.

In the drawings:

FIG. 1 is a cross-sectional, exploded view of a fire resistant laminate in accordance with the present invention;

FIG. 2 is a cross-sectional view of the laminate of FIG. 1 that has been assembled with additional layers to illustrate a configuration of a door;

FIG. 3 is a perspective view of a fire resistant laminate;

FIG. 4 is a perspective view of another embodiment of a fire resistant laminate;

FIG. 5 is a cross-sectional, exploded view of an organic/inorganic composite in accordance with the present invention;

FIG. 6 is an exploded, perspective view of a fire resistant I-beam assembly in accordance with the present invention;

FIG. 7 is a perspective view of the assembled I-beam of FIG. 6;

FIG. 8 is a graphic plot of performance temperature versus time of a fire test;

FIG. 9 is a graphic plot of temperature versus time of the performance of laminates in a furnace run.

FIG. 10 is a graphic plot of temperature versus time of the performance of additional laminates in a furnace run.

FIG. 11 is a graphic plot of temperature versus time of the performance of I-beam laminates in a furnace run.

FIG. 12 is a flow diagram showing some of the numerous different types of laminate systems that can be made according to the present invention.

### DETAILED DESCRIPTION OF THE INVENTION

An important aspect of the present invention is the utilization of at least one layer of the system or laminate which contains the inorganic polymer matrix composition usually in association with a reinforcing material. The inorganic polymer matrix composition of the present invention is prepared by reacting an alkali silicate solution, a non-silicate network former and/or a reactive glass, water, and optionally, one or more secondary network-linking units such as multivalent cation(s) selected from Groups 2, 3, 4, 5, 6, 7, 8, 9, 10, 11, 12, 13, 14, 15 or 16 of the Periodic Table such as alkaline earth salt and optionally one or more fillers. Alternately, the reaction of a silica source, an alkali base, water, a non-silicate network formers and/or acidic reactive glass, and optionally, one or more network modifiers, and/or one or more filler(s), can yield a high-temperature inorganic polymer matrix composition. Additional components such as functional and/or nonfunctional fillers, other network forming materials and modifiers can be incorporated as needed or desired.

The modified alkali silicate composition that is obtained can be cured at relatively low temperatures (<200° C.), and at low pressures (<200 psi) to produce an inorganic polymer network having dimensional and thermal stability to 1000° C. and higher. That is, a structure incorporating a matrix composition of the present invention exhibits no substantial permanent dimensional change at temperatures to 700° C. and higher. However, it is not restricted to the lower temperature or pressure, and if needed, or desired, properties can be further enhanced utilizing elevated processing temperatures (up to 1000° C. and higher) and pressures (up to 20,000+ psi), and/or incorporating post-cure heat treatments.

An approximate chemical composition of the invention, that is a qualitative representation of the starting materials, which is derived from the aqueous mixture before curing to form the inorganic matrix, can be described as follows:
(1−n)(aA₂O:SiO₂:bB:cC:dDₓ).nH₂O Formula I
Where:
A (1−z)K₂O or (z)Na₂O, where z can vary between 0 and 1, K₂O is potassium oxide, and Na₂O is sodium oxide, Li₂O and/or an equivalent such as LiOH can also be incorporated, if desired.
SiO₂ is silica, which can be derived from a silica source such as Kasil-1, silica fume, silica, silica gel or a combination thereof,
H₂O is water,
a=molar ratio of A₂O: SiO₂, which ranges from 0.05 to 1.0,
b=molar ratio of B: SiO₂, which ranges from 0.001 to 0.500,
c=molar ratio of C: SiO₂, which ranges from 0.0 to 0.250,
d=is the molar ratio of D: SiO₂ and ranges from 0.0 to 2.000,
n=molar ratio of H₂O incorporated into the formulation, for which during initial formulation, the desired range is from 0.10 to 0.90, with n=0.15 to 0.35 being preferred; and after cure, n is less than 0.25, with n<0.05 being preferred,
x=is the number of additives (D) used to aid in processing and performance of the basic formulation and ranges from about 0 to about 20,
B=non-silicate network formers, such as phosphate, sulfate, or borate groups, derived from an acidic precursor, such as H₃PO₄, H₂SO₄, H₃BO₃, a combination thereof and/or a reactive glass such as an alkaliborophosphate or an alkali phosphoborate glass,
C=network modifiers such as Mg²⁺, Ca²⁺, Zn²⁺, Al³⁺, Ti⁴⁺ derived from multivalent main group metal and/or transition metal compounds such as Mg(NO₃)₂, ZnCl₂, or a combination thereof or as a metallic component of a reactive glass, and
D=optional additives selected from one or more, alone or in combination, of
(i) reactive and/or non-reactive fillers such as but not limited to kaolin, smectites, hormites, mica, vermiculite, metakaolin, metal oxides, or a combination thereof;
(ii) gelation modifiers such as an organic base (quinoline) and/or an organic acid (lactic acid);
(iii) a surface-active agents such as an anionic, cationic and/or nonionic surfactant such as but not limited to alkylaryl sulfonates, quaternary ammonium salts, protonated organoamine salts, organic-inorganic hybrids such as silicones or combinations thereof; and
(iv) organic-based toughening and/or plasticizing agents which can be in the form of resin, low molecular weight and/or high molecular weight polymers.

Processing aids can also be added if needed, and include mineral oils, vegetable oils, animal oils, silicon oils, fatty acids and salts, aliphatic alcohols, fluorinated oils, waxes, polyolefins (such as for example, but not limited to, polyethylene, oxidized polyethylene, and polytetrafluoroethylene), graphites, surfactants and mixtures thereof.

An alternate expression of the chemical composition of the invention incorporating a reactive glass can be also described as follows:
(1−n)(aA₂O:SiO₂:gG:fFₓ).nH₂O Formula 2
where:
A=(1−z) K₂O or (z) Na₂O, wherein z can vary between 0 and 1, K₂O=potassium oxide, Na₂O=sodium oxide, Li₂O and/or an equivalent such as LiOH can also be incorporated, if desired,
SiO₂=silica, derived from a silica source such as Kasil-1, silica fume, silica, quartz or silica gel, or a combination thereof,
G=a reactive glass such as an alkaliborophosphate or an alkaliphosphoborate glass,
Fₓ=optional additives and/or nonsilicate network former(s), such as one or more, alone or in combination, of the following:
(i) P₂O₅, B₂O₃, or SO₃, derived from acidic precursors such as H₃PO₄, H₃BO₃ or H₂SO₄, or combinations thereof,
(ii) network modifier(s) such as Mg²⁺, Zn²⁺, Al³⁺, Ti⁴⁺ derived from multivalent main group metal and/or transition metal compounds such as Mg(NO₃)₂, ZnCl₂, or a combination thereof,
(iii) reactive and/or non-reactive fillers such as kaolin, smectites, hormites, mica, vermiculite, metakaolin, metal oxides, or a combination thereof,
(iv) gelation modifiers such as an organic base (quinoline) and/or an organic acid (lactic acid),
(v) surface-active agents such as an anionic, cationic and/or nonionic surfactant such as but not limited to alkylaryl sulfonates, quaternary ammonium salts, protonated organoamine salts, organic-inorganic hybrids such as silicones or combinations thereof,
(vi) organic-based toughening and/or plasticizing agents which can be in the form of resins, low molecular weight and/or high molecular weight polymers.

H₂O=water,
a=molar ratio of A₂O: SiO₂, which ranges from 0.05 to 1.00,
g=molar ration of G: SiO₂, which ranges from 0.01 to 0.500,
f=molar ration of F: SiO₂, which ranges from 0.000 to 2.000,
x=0 to about 20 and represents the number of additives (F) used to aid in processing and performance of the basic formulation, and
n=molar ratio of H₂O incorporated into the formulation, where during initial formulation, the range is from 0.10 to 0.90, with n=0.15 to 0.35 being the preferred embodiment, and after cure, n is less than 0.25 with n<0.05 being preferred.

Processing aids can also be added, if needed, and include mineral oils, vegetable oils, animal oils, silicone oils, fatty acids and salts, aliphatic alcohols, fluorinated oils, waxes, polyolefins (such as for example but not limited to polyethylene, oxidized polyethylene, and polytetrafluoroethylene), graphites, surfactants or combinations thereof.

The alkali silicates utilized in this invention can include a wide range of silica/alkali oxide (SiO₂/A₂O) ratios and % solid levels. Such solutions can be purchased from commercial sources or prepared immediately prior to use from precursors such as a silica source and an alkali hydroxide, alkali oxide, carbonate or combinations thereof. The alkali silicate can be derived from an alkali base, such as potassium hydroxide or sodium hydroxide, from potash or soda ash and a silica source. The SiO₂ source can be an amorphous or crystalline SiO₂, such as silica, silica fume, precipitated silica, fumed silica, microsilica, sand, microcrystalline silica, silica gels, colloidal silica, quartz, quartz flour, a sodium silicate solution, a potassium silicate solution as well as solid sodium and/or potassium silicates. An example of a commercially available alkali silicate is Kasil-1, available from PQ Corporation, Valley Forge, Pa. Various silica sources exhibit desired as well as undesired attributes. For example, some silica fume sources contain traces of carbon that can lead to discoloration in the final product. In addition, the thermal and physical properties of the inorganic polymer matrix composition can be influenced by the nature of the silica source, for example, the incorporation of a dense crystalline α-quartz network can enhance dimensional stability while, in turn, introducing an open, amorphous silica source will produce a lower density network. However, an appropriate alkali silicate solution can be achieved by a combination of various sources of alkali and/or silica. When the alkali silicate is derived from an alkali hydroxide and a silica source, the alkali hydroxide is present in an amount of about 3 wt. % to about 30 wt. % based upon the weight of the total composition or mixture, preferably about 7 wt. % to about 20 wt. %. The silica source is present in an amount of about 10 wt. % to about 85 wt. % or about 90 wt. % or about 94 wt. %, preferably 15 wt. % to 70 wt. %. In some cases, for example, when an alkali silicate solution is used, a portion of the alkali hydroxide, silica and water provided is included in the ranges disclosed.

The alkali silicate used in the preparation of the inorganic resin composition is potassium silicate solutions, sodium silicate solutions, crystalline sodium silicate, crystalline potassium silicate, amorphous sodium silicate, amorphous potassium silicate, and mixtures thereof. Alternatively, the alkali silicate precursors are and alkali base and a silica source. The silica in the alkali silicate is an amorphous or crystalline silica form, selected from the group consisting of silica, silica fume, microsilica, precipitated silica, sand, quartz, quartz flour, silica gels, fumed silica and colloidal silica. Preferably, the alkali silicate and/or alkali silicate precursors has a SiO₂/A₂O ratio of about 2.0:1.0 to 20.0:1.0, where A is K (potassium) and/or Na (sodium), and wherein the alkali hydroxide is selected from the group consisting of potassium hydroxide and sodium hydroxide.

Non-silicate network formers can be introduced if desired in the range of about 2 wt. % to 70 wt. %. A non-silicate network former can be added as an acidic oxoanionic compound. Examples of acidic oxoanionic compounds include boric acid, phosphoric acid, sulfuric acid, sodium dihydrogen phosphate, disodium hydrogen phosphate, dipotassium hydrogen phosphate, potassium dihydrogen phosphate, ammonium hydrogen phosphate, metallic and/or nonmetallic phosphate salts or compounds incorporating borate, sulfate, aluminate, vanadate, germinate, and the like ions and combinations or mixtures thereof. A non-silicate network former can also be added as a non-acidic oxoanionic compound such as trisodium phosphate, potassium phosphate, sodium borate or similar salts of acids if the pH of the mixture is adjusted by other means. The preferred mixture of acidic oxoanionic compounds include mixtures of potassium dihydrogen phosphate and boric acid; sodium dihydrogen phosphate and boric acid; potassium dihydrogen phosphate, sodium dihydrogen phosphate and boric acid; sodium borate and potassium dihydrogen phosphate, which can be used in any grade or concentration although a more concentrated material is preferred to minimize the water content. The acidic oxoanionic compound is present in an amount of between about 0.01 wt. % and 20 wt. % based upon the total composition. The preferred amount of acidic oxoanionic compound is between about 2 wt. % to about 8 wt. %. Compounds that incorporate multivalent atoms and acidic oxoanions can also be incorporated. Examples include monoaluminum phosphate (Al(H₂PO₄)₃, aluminum metaphosphate (Al(PO₃)₃, monobasic magnesium phosphate, magnesium hydrogen phosphate, zinc dihydrogen phosphate, monocalcium phosphate, calcium hydrogen phosphate, monobasic barium phosphate, dibasic barium phosphate, manganese dihydrogen phosphate, manganese hydrogen phosphate and similar metal phosphates.

Alternatively, a non-acidic oxoanionic compound can be used as a network former. Examples of such compounds include trisodium phosphate, potassium phosphate, sodium borate or similar salts of acids, if the pH of the mixture is adjusted by other means. It is believed that the non-acidic oxoanionic compounds can be added in an amount similar to acidic oxoanionic compounds.

Alternatively, a reactive glass can be used in conjunction with the alkali silicate solution to form the composition. The phrase “reactive glass” encompasses a wide variety of acidic inorganic glasses that can contribute an acid group in the condensation reaction between the alkali silicate and the glass that occurs during the curing step. Reactive acidic glasses are preferred, and examples of reactive acidic glasses include borophosphosilicate, phosphate, phosphoborate, borophosphate and borate glasses. There may be reactive glasses which are not truly acidic, but which function in the same manner. A non-acidic glass (pH about 7 to about 10) can be used provided the pH of the reactive glass is less than that of the pH of the alkali silicate component and/or its precursors. Elevated processing conditions may be necessary to consolidate such a composition including higher temperatures (>200° C.) and/or higher pressures (>200 psi). Reactive glasses are different from essentially nonreactive structural glasses as used in beakers and drinking vessels, and optical glasses as used in windows. Reactive glasses are made according to typical glassmaking processes by combining oxide reactants. In the case of an alkali borophosphate glass, P₂O₅, B₂O₃, and one or more alkali oxides or their precursors are combined in a powder form and heating the mixture to its fusion temperature of about 700° C. to about 1500° C. and then rapidly cooling the melt and optionally annealing the glass to a rigid, friable state. The ratio of phosphoric oxide to alkali metal oxide (A₂O) will be about 6.1:1.0 to 1.5:1.0. In the case of an alkali phosphoborate glass, B₂O₃, P₂O₅ and one or more alkali oxides or their precursors are combined in a powder form and heating the mixture to its fusion temperature of about 700° C. to about 1500° C. and then rapidly cooling the melt and optionally annealing the glass to a rigid, friable state. The ratio of phosphoric oxide to alkali metal oxide (A₂O) will be about 5.0:1.0 to 1.15:1.0 and the ratio of boric oxide to alkali metal oxide (A₂O) will be about 8.0:1.0 to 1.5:1.0.

Preferably, the glass solid is pulverized to form a powder. Reactive borophosphate glass powder is the preferred powder. The use of this preferred glass powder facilitates control of the cure rate and the amorphous nature of the matrix. The thermal and physical properties of the inorganic silicate/glass matrix can be varied by adjusting the ratio of SiO₂ to the reactive glass and/or glass precursors (G). The G:SiO₂ ratio can vary from 0.01 to 50.0 by weight. The reactive glass is used in an amount of between about 0.01% to 60% by weight of the total mixture, with 3% to 35% being preferred, and 5% to 20% by weight being the most preferred.

Since it is desired that the glass formed is acidic, the composition of the glass will consist primarily of the glass formers such as the oxides of phosphorus, boron and optionally silicon. The preferred alkali oxide is lithium oxide. If a high phosphorus glass is needed, the glass composition before fusion will comprise about 20 mol % to about 80 mol % of phosphorus pentoxide (P₂O₅), or its salts, acids, or other precursor forms, which provide the right or equivalent amounts of phosphorous and oxygen based upon the total glass formulation, preferably 30 mol % to 70 mol %, with 35 mol % to 65 mol % being further preferred. Most preferably, 60 mol % to 65 mol % is used. The boron oxide (B₂O₃) will comprise about 1 mol % to 15 mol % of the glass, with 2 mol % to 8 mol % being preferred and 4 mol % to 6 mol % further preferred. The alkali oxide (A₂O) comprises about 5 mol % to 50 mol % of the glass composition, with 20 mol % to 40 mol % being preferred, and 15 mol % to 30 mol % further preferred. The alkaline earth oxide (M′O) is used in an amount of between about 0.01 mol % to 30 mol % of the total glass mixture, with 5 mol % to 20 mol % being preferred, and 10 mol % to 15 mol % being further preferred. Other oxides can be incorporated as desired, such as including but to limited to aluminum oxide, iron oxide, lanthanum oxide, cerium oxide, molybdenum oxide and silicon dioxide. These oxides are added at up to 20 mol %.

If a high boron glass is needed, the glass composition before fusion will comprise about 10 mol % to about 50 mol % of phosphorus pentoxide (P₂O₅), or its salts, acids, or other precursor forms, which provide an equivalent amounts of phosphorus and oxygen based upon the total glass formulation, preferably 20 mol % to 40 mol %, with 25 mol % to 35 mol % being further preferred. The boron oxide (B₂O₃) will comprise about 10 mol % to 70 mol % of the glass, with 30 mol % to 60 mol % being preferred and 45 mol % to 55 mol % further preferred. The alkali oxide (A₂O) comprises about 5 mol % to 45 mol % of the glass composition, with 20 mol % to 40 mol % being preferred, and 15 mol % to 30 mol % further preferred. The alkaline earth oxide (M′O) is used optionally in an amount of between about 0 mol % to 30 mol % of the total glass mixture, with 5 mol % to 20 mol % being preferred, and 10 mol % to 15 mol % being further preferred if used.

The formulation of the reactive glass, if used, is critical to the chemistry and the performance of this invention. It is desired that the glass react with the alkali silicate mixture to reduce the basicity of the resulting matrix and to conjoin multiple networks. The combination of very different networks, one silicate-based and the other phosphate-based results in a blend of an amorphous inorganic polymer and a crystalline network as well as new network units formed by reaction of the basic silicate and the acidic phosphate such as —Si—O—P—. Both silicate and phosphate species are known to be excellent network formers form the basis for this invention.

The reactive glass that can be used to form the composite can be concisely described by the following formula:
ⁿπ((M^{p+})_{q′})(E^{q-})_{p′})ᵣ^{^{k}} where Σrₖ=1 k=1 Formula 3
where:
n number of desired glass components,
M=at least one glass former, such as boron, silicon, phosphorus, sulfur, germanium, arsenic, antimony, aluminum, and vanadium, and at least one glass modifier which functions as a flux, such as lithium, sodium, potassium, rubidium and cesium, and, optionally, additional network modifiers such as vanadium, aluminum, tin, titanium, chromium, manganese, iron, cobalt, nickel, copper, mercury, zinc, thulium, lead, zirconium, lanthanum, cerium, praseodymium, neodymium, samarium, europium, gadolinium, terbium, dysprosium, holmium, erbium, thulium, ytterbium, actinium, thorium, uranium, yttrium, gallium, magnesium, calcium, strontium, barium, tin, bismuth, and cadmium,
E=oxygen, chalcogenides and/or halogens such as sulfur, selenium, tellurium and fluorine,
p=cation valence of M, such as 5 for phosphorus, which is generally portrayed as P⁵⁺ or P(V)),
q=anion valence of E such as 2 for oxygen, which is generally portrayed as O²⁻,
q′=number of M cations contained in a network unit equal to q or q/2 whichever is the lesser whole number whenever p and q are even numbers, such as 2 for phosphorus in P₂O₅ or 1 for silicon in SiO₂,
p′=number of E anions contained in a network unit equal to p or p/2 whichever is the lesser whole number whenever p and q are even numbers, such as 5 for phosphorus in P₂O₅ or 2 for silicon in SiO₂,
r=molar fraction of each individual network unit in the reactive glass component,
n=number of total network units in the reactive glass component.

A binary glass can be represented by {(M₁^{p+})_{q′})(E₁^{q-})_{p′}}ᵣ₁{(M₂^{p+})_{q′})(E₂^{q-})_{p′}}ᵣ₂, r₁+r₂=1 and a ternary glass can be generalized as {(M₁^{p+})_{q′})(E₁^{q-})_{p′}}ᵣ₁{(M₂^{p+})_{q′})(E₂^{q-})_{p′}}ᵣ₂{(M₃^{p+})_{q′})(E₃^{q-})_{p′}}ᵣ₃, r₁+r₂+r₃₌₁. Thus a soda-lime glass can be described as (CaO)ᵣ₁(SiO₂)ᵣ₂(Na₂O)ᵣ₃ where r₁+r₂+r₃=1. Silicon (Si) is a glass former covalently bound to oxygen to yield the glass network and sodium (Na) and calcium (Ca) are glass modifiers that bond ionically to the silicate network aiding in the formation and durability of the glassy phase. Therefore, M generically represents at least one glass network former (M_{gf}) and at least one glass network modifier (M_{gm}) in the glass recipe.

The refining time and temperature of the glass also influences its physical and mechanical characteristics. For a constant composition increasing the refining temperature and/or time further densities the glass network raising the T_{g}, Tₛ and Tₘ, reducing network activity and the hydroxyl/H₂O content of the glass while enhancing durability. Thus by varying the glass composition, the glass refining time and temperature, various glass formulations can differ greatly with regard to reactivity, durability, acidity, hydrolytic stability, toughness and processing. Modest levels of silica and/or alumina may be optionally added to limit furnace contamination and/or strengthen the glass network if needed for very high temperature resistance (>900° C.). The matching, blending and adjustment of the glass and the alkali silicate properties allows the formulation of a high-temperature material with unique and novel properties. In other words, the ability to vary these “building blocks” enables one to tailor product properties to suit numerous high-temperature applications.

The particle size of the reactive glass, as is the particle size of the additional ingredients, is important, but not critical. Obviously, reactivity of the ingredients increase as the particle size decreases and if the particles are too fine then the materials may be too reactive, thus adjustments may be needed to be made in the components employed to make the compositions of the present invention. The powder components of the composition (silica, reactive glass, etc.) can be prilled, granulated, pelletized or otherwise compacted prior to addition to the liquid portion of the composition.

Although the invention is the inorganic polymer matrix composition resulting from the reaction of the alkali silica source and the a non-silicate network former and/or reactive glass, the mechanical, the physical and processing characteristics of the matrix can be enhanced by the additional components as desired. Additional components such as fillers, other network forming materials and modifiers can be incorporated as needed. These include additives, network formers, and fillers typically used or known to ones skilled in the art, whether inorganic, organic or hybrid, and can include additives or fillers to permit processing, fabrication and enhanced performance in service.

The optional additives and/or additional network former(s) can be compounds such as borates, sulfates, aluminates, vanadates, boric acid, phosphoric acid, sulfuric acid, nitric acid, phosphorus pentoxide, sodium dihydrogen phosphate, disodium hydrogen phosphate, potassium hydrogen phosphate, dipotassium hydrogen phosphate, ammonium hydrogen phosphate, other metallic and/or nonmetallic phosphate salts, germanates, or the like. The optional network former(s) are present in an amount of between 0.0 wt. % and 50 wt. % based upon the total composition. If included in the formulation, the preferred amount of the F₁ network former would be between 2 wt. % to about 10 wt. %.

The secondary network-linking units can be multivalent cations which are used will be selected from Groups 2, 3, 4, 5, 6, 7, 8, 9, 10, 11, 12, 13, 14, 15 and 16, preferably from Groups 2, 3, 4, 5, 11, 12, 13, 14, 15 and 16 of the Periodic Table and are used in an amount of between zero and about 20 wt. % based upon the total mixture, with the ranges of about 1.0 wt. % to about 5 wt. % is preferred. Multivalent cations Cr, Mo, W, Mn, Fe, Co, Ni, Pd, and Pt of the Groups 6, 7, 8, 9, and 10, also can be used, but ones from the other Groups are preferred. The multivalent cation containing compounds can comprise any main group metal salt including nitrates, sulfates and chlorides, although salts of zinc, magnesium and calcium are preferred. The optional secondary network-linking unit can be a multivalent cation useful for coordinating with oxo species such as the alkaline earths, main group metals, transition metal species, lanthanides and/or actinides and any useful combination thereof. Other secondary network-linking units can include compounds incorporating boron, aluminum, lead, gallium, cadmium, titanium, zirconium, lanthanum, cerium, neodymium, yttrium, strontium, barium, lithium, rubidium, cesium, and fluorine.

The optional additives that can be used include clay fillers, oxide fillers, gel modifiers, organic toughening agents, plasticizing agents or combinations thereof. Fillers include kaolin, metakaolin, montmorillonites, mica as well as other smectites and other clay or mineral fillers. When clay fillers are employed, calcined kaolin is preferred, and can be used in an amount from zero to 25 wt. % based upon the weight of the total composition, with 3 wt. % to 5 wt. % being preferred. The calcined kaolin may have some reactivity with the silicate matrix material, although reactivity of the clay filler is not required, and any of the commercially available clay fillers can be employed.

The optional oxide fillers that could be employed include oxides of boron, aluminum, silicon, zinc, gallium, titanium, zirconium, manganese, iron, molybdenum, tungsten, bismuth, lead, lanthanum, cerium, neodymium, yttrium, calcium, magnesium and barium and is present in an amount of between about 0.0 wt. % and about 20 wt. % based upon the total composition weight. Magnesium oxide (MgO, which is preferred) and is used in an amount of zero % to 15% by weight based upon the total weight of the composition, with 1% to 10% by weight being preferred and 2% to 8% by weight being further preferred.

Modifiers can include crosslinkers and gel inhibitors or promoters such as mineral acids, organic acids and bases. Crosslinkers can also be introduced as metal phosphates as described earlier. These include aluminum phosphate, magnesium phosphate, calcium phosphate, zinc phosphate, iron phosphate, cerium phosphate, lanthanum phosphate, barium phosphate, monoaluminum phosphate (Al(H₂PO₄)₃), aluminum metaphosphate (Al(PO₃)₃), monobasic magnesium phosphate, magnesium hydrogen phosphate, zinc dihydrogen phosphate, monocalcium phosphate, calcium hydrogen phosphate, monobasic barium phosphate, dibasic barium phosphate, manganese dihydrogen phosphate, manganese hydrogen phosphate and similar metal phosphates.

The optional gel modifier is an organic acid and/or organic base generally selected from the group consisting of hydroxyacids and N-based and P-based bases. Examples of organic acids include lactic acid and citric acid. Preferably α-hydroxyacids, β-hydroxyacids, substituted pyridines and quinolines are used. These are utilized in an amount from none to 10 wt. % based upon the weight of the total composition, with 0.05 wt. % to 5 wt. % being preferred. The optional surface-active agent is an anionic, cationic and/or a nonionic surfactant such as but not limited to alkylaryl sulfonates, silicones, quaternary ammonium salts, protonated organoamine salts, hydroxyl polymers, organic-inorganic hybrids such as silicones or combinations thereof. These additives are utilized in an amount from none to 10 wt. % based upon the weight of the total composition, with 0.5 wt. % to 5 wt. % being preferred.

The optional organic toughening agent and/or plasticizing agent is an organic-based toughening agent, plasticizing agent, or combinations thereof. The organic based toughening agents can be chosen from the group consisting of resins, low molecular weight and/or high molecular weight polymers. These are utilized in an amount from none to 10 wt. % based upon the weight of the total composition.

The balance of the uncured composition is water and it will comprise about 10 wt. % to about 75 wt. % based upon the total composition weight. The range of 15 wt. % to 40 wt. % is preferred. The water can be introduced as part of one of the components, such as part of an alkali silicate solution, an alkaline earth salt solution or part of a phosphoric acid solution. Since the water incorporated in this invention can be viewed as a reaction medium, a reactant as well as a reaction product, the concentration of water can be difficult to quantify in general. The initial level of water in the starting mixture can vary from about 10 wt. % to about 70 wt. % while a B-staged prepreg may contain about 5 wt. % to about 35 wt. % water. A cured sample of the inorganic binder by itself as well as the composite can contain about 0 wt. % to about 10 wt. % water depending upon the processing conditions.

As noted above, a very important aspect of the present invention is the desirable use of a reinforcing medium desirably of woven and/or non-woven, continuous and/or discontinuous fibers, which are utilized in the alkali silicate resin layer. Reinforcement can range from about 2 vol % to about 60 vol %. Reinforcing fibers may include nickel fibers, glass fibers, carbon fibers, graphite fibers, mineral fibers, oxidized carbon fibers, oxidized graphite fibers, steel fibers, metallic fibers, metal-coated carbon fibers, metal-coated glass fibers, metal-coated graphite fibers, metal-coated ceramic fibers, nickel-coated graphite fibers, nickel-coated carbon fibers, nickel-coated glass fibers, quartz fibers, ceramic fibers, silicon carbide fibers, stainless steel fibers, titanium fibers, nickel alloy fibers, brass-coated steel fibers, polymeric fibers, polymer-coated carbon fibers, polymer-coated graphite fibers, polymer coated glass fibers, polymer-coated aramid fibers such as Kevlar®, ceramic-coated carbon fibers, ceramic-coated graphite fibers, ceramic-coated glass fibers, oxidized polyacrylonitrile fibers, basalt fibers, alkaline resistant glass fibers, and/or other fibers known to those knowledgeable in the arts. Combinations of these various fibers can also be used. Preferably, the fibers are graphite fibers, E-glass fibers, S-glass fibers, basalt fibers, stainless steel fibers, titanium fibers, nickel alloy fibers, aramid fibers, polyethylene fibers, SiC fibers and BN fibers. These fibers can also be coated and/or treated. Examples of suitable coatings to be used on the fibers include vapor deposited metal and metal alloys, chemically deposited metal and metal alloys, metals and metal alloys applied in a molten state, electrolytically applied metals and metal alloys, organic polymer coatings, inorganic-organic polymer hybrid coatings, metal oxides, phosphates, metal phosphates, silicates, organic polymer-silicate and organic polymer-silica hybrids and functionalized siloxanes.

Reinforcing fibers may be in many forms, including yarns, tows, whiskers, continuous fibers, short fibers, woven fabrics, woven sheets, knitted fabrics, non-woven fabrics, random mats, needled mats, screens, felts, braided fabrics, wound tows, wire and/or other forms known to those knowledgeable in the arts.

Glass fiber reinforcement (including for example but not limited to E-glass fibers, S-glass fibers, or alkali resistant glass fibers) can be used as a reinforcing material. Composite structures can also incorporate hybrid fiber reinforcements such as combinations of glass, carbon, organic polymer, oxide and/or metal fibers. The reinforcement can be in the form of woven or non-woven fabric, mesh, screen, wool, continuous or non-continuous fibers. The different fibers and/or fabrics can be commingled throughout the matrix or discretely separated into layers. Examples include alternating layers of carbon and glass fiber reinforcement as well as steel screen sandwiched between glass veils. The composite materials using glass fiber reinforcement and the matrix binder of the present invention are affordable, non-combustible, thermally-stable [for example, no measurable (<0.2%) permanent dimensional change after 48 hours of exposure at 700° C.] composite materials with insulating qualities and structural qualities that can be processed at lower temperatures using typical processing equipment. Normal processing can be at relatively low temperatures (<200° C.) and low pressure (<200 psi). A cross-ply glass fiber laminate can be produced with thermal insulating qualities (for example, thermal conductivity of nominally 1.4 W/m-K), electrical insulating qualities (no detectable electrical conductivity when measured with a standard ohm meter) and modest mechanical performance (flexural modulus up to 18 Msi, flexural strength to 200+ ksi, and ultimate flexural strains up to 1.3%). This combination of properties should be enabling technology for many applications. Ceramic fiber reinforcement (including silicon carbide fibers) is another preferred reinforcement, especially for high temperature applications above 700° C. Although expensive, ceramic fibers maintain structural integrity well above 1000° C. Carbon fiber reinforcement is a preferred reinforcement where electrical conductivity, thermal conductivity, high strength and/or impact resistance is desired.

The mechanical properties of a composite structure incorporating the inorganic polymer matrix composition can be enhanced provided there is sufficient interaction between the matrix and the reinforcement. A composite structure incorporating the inorganic polymer matrix composition provides an enhanced level of mechanical strength if the reinforcement exhibits some degree of oxophilic character at the matrix-reinforcement interface. A composite structure comprising the inorganic polymer matrix composition and stainless steel reinforcement exhibits an enhanced level of mechanical performance. The improvement is better illustrated when using a carbon or graphite fiber as reinforcement. Carbon and/or graphite fibers are inherently nonpolar and hydrophobic but can be treated in a variety of ways to develop regions of hydrophilic character such as the application of sizing or other coatings (generally organic polymers such as epoxies or organosilanes) or through the use of surfactants. Generally enhancing the hydrophilic nature of fiber will also create a more oxophilic surface and improve the interface between the reinforcement and the matrix but the reinforcement can be made more oxophilic by other means. Metallization of the fiber can develop an oxophilic surface that will significantly enhance the interfacial strength of the composite structure. Chemical, thermal and electrolytic oxidation of carbon, graphite and/or polymeric reinforcements can also enhance oxophilicity and thus the interfacial strength and mechanical properties of the composite structure. Furthermore, the fiber can be sized with an organic polymer combined with an inorganic oxide particulate such as a glass frit, reactive glass frit, silica, alumina, zirconia and similar oxide-based materials. This imparts an oxophilic character to the surface of the reinforcement. These concepts can extend also to other oxo-based matrix compositions including but not limited to alkali silicate resins, metal phosphate resins, cementitious materials, refractory compounds and other oxide-based inorganic and/or inorganic/organic hybrid materials. Ensuring that the surface of the reinforcement media has sufficient irregularity or roughness to promote a beneficial mechanical interaction can also enhance the interface between the matrix and the reinforcement.

In addition, the inorganic polymer matrix compositions may incorporate a wide variety of organic and inorganic fillers commonly used by those knowledgeable in the art. The matrix may incorporate filler materials such as ceramic powders, mineral powders, metallic powders, silicon carbides, silicon nitrides, silicates, boron nitrides, aluminosilicates, aluminum silicates, sodium aluminum silicates, potassium aluminum silicates, carbon, carbon black, carbon nanotubes, molybdenum and its compounds, or other fillers known to those knowledgeable in the arts. Organic materials are less preferred where the application is such that the organic materials will combust and produce gases. The filler materials also could be spheres such as microspheres, macrospheres, hollow and/or solid spheres, and/or cylindrical, flat and/or irregular or non-irregular shaped particles.

The inorganic polymer matrix composition of the present invention influences the pH of the solution containing the alkali silicate backbone by incorporating an acidic inorganic component (such as a protonated oxoanions such as phosphoric or boric acid, dihydrogen phosphate or reactive glasses) and acidic salt modifier such as an alkaline earth salt. The alkali silicate solutions require a high pH to maintain a high concentration of monomeric silicate anions needed to moderate network formation. The ability to cure under moderate conditions after reducing the pH to a lesser value reduces the damage to the glass fiber reinforcement induced by the alkalinity of the matrix. The inorganic matrix binder cures via a condensation reaction partially driven by the elimination of water from the framework and excessive water in the binder leads to a lack of dimensional stability, poor physical properties and difficulty in processing.

As can be appreciated, the inorganic polymer matrix compositions of the present invention can be fabricated and processed into composites using compression molding, bulk molding compound, sheet molding compound, powder and reinforcement, liquid and reinforcement, prepreg and sintering. Additional methods include pultrusion (an automated process capable of producing a constant cross-section product), wet lay-up (a simple manual process for rapid prototypes and affordable low performance products), filament winding (an automated process for bodies of revolution), vacuum bag processing (a typical process for high performance aerospace laminates), autoclave or non-autoclave, vacuum infusion (a process for large thick high-performance parts), liquid resin, film infusion or powder infusion, resin transfer molding (a near net-shape molding process with excellent dimensional repeatability), extrusion (a process capable of producing constant cross-section non-structural short-fiber products), injection molding (an automated process capable of producing small non-structural short-fiber products), casting (a process for bulk non-structural products), spin casting (a process capable of producing high-quality tubing), trapped elastomer molding (a process capable of producing unusual shapes), and like processes.

The composite is cured within a temperature range of about 15° C. to about 1000° C. and higher, and a pressure range from 0 psi to about 2000 psi, preferably at a temperature between about 50° C. to about 200° C. and at a pressure less than about 200 psi.

If desired, the composite part can be thermally post-cured and/or chemically treated to further enhance thermal, dimensional or hydrolytic stability or combinations thereof. The part can be thermally treated in air, in vacuo or in an inert atmosphere within a temperature range of about 15° C. to about 1000° C. The composite part can be washed with water or other solvent to remove excess reactants. Furthermore, this can be done after only partial formation of the inorganic polymer network prior to completion of the curing process. The composite part can also be contacted with acid solutions, metal salt solutions, metal acid salt solutions, surfactant solutions, solutions of fluorinated compounds, silicon-based compounds, organic prepolymers, ionomers, polymers and/or other solutions intended to impart hydrophobicity.

For example, immersion or coating of a composite structure with a dilute solution of phosphoric acid can enhance both the thermal as well as the hydrolytic stability of the composite structure. The phosphoric acid may be in solution with one or more metallic salts. Similar improvement can be achieved using a dilute solution of a magnesium salt alone or in combination with the phosphoric acid solution. Other soluble polyvalent metallic salts such as those containing aluminum, calcium, zinc, cerium, lanthanum and/or similar salts can be used also. Solutions of monovalent metallic salts such as lithium hydroxide, lithium acetate, lithium chloride and so forth can also be contacted with the composite structure if desired.

These processes have several advantages compared to the curing/consolidation methods normally used in making high temperature inorganic polymers, namely ceramics and glasses. Ceramic and glass processing typically requires high temperature processing equipment (above 1000° C.). The nature of the inorganic matrix formulation of the present invention allows composites to be processed with conventional equipment found in composite manufacturing facilities. These processes allow a more rapid throughput than typical ceramic processes and enable the easy manufacturing of larger parts than typical ceramic processes. The use of these processes allows high fiber volumes for structural integrity, which is superior to regular concrete processing.

Alternatively, the inorganic polymer matrix composition of the present invention is not solely limited to composites. The composition can be used to form neat resin components, coatings and adhesives.

As can be appreciated, the present invention can be formulated to be non-combustible. This desirable safety feature differentiates the invention from most organic materials (such as for example but not limited to plastics, wood, or rubber) that tend to combust, generate smoke and/or toxic gases upon exposure to fire. Further, the present invention can be formulated to be a thermal insulator and/or an electrical insulator. This desirable feature differentiates compositions in accordance with the present invention from most metals (such as steel, aluminum, or copper) that tend to be thermal and electrical conductors.

The present invention can be formulated to perform at high temperatures (>1000° C.) with negligible permanent changes in dimensions. This desirable feature differentiates the invention from most organic materials (which tend to pyrolyze when exposed to temperatures above 500° C.), from most cement formulations (which tend to spall above 300° C.) and from many metals (including aluminum) that tend to warp or melt at 700° C. As a further feature, the present invention can achieve high temperature performance (up to and above 1000° C.) while being processed at relatively low temperatures, (<200° C.) and low pressures (for example but not limited to <200° C. and <200 psi). This feature is desirable because the ability to process at low temperatures and pressures allows the invention to be processed with more affordable equipment and manufacturing processes. This feature of the chemistry differentiates the present invention from most ceramics, glasses and metals, which generally require very high temperatures and/or high pressures to create a molded shape. (Of course, the invention also can be effectively processed at higher temperatures and pressures; the material has been processed at pressures above 10,000 psi and at temperatures above 1500° C.).

In some instances, an application may require a thermal barrier to resist a flame and/or elevated temperatures for a single service cycle and then replaced or applications at reduced service temperatures, which do not need to withstand extreme temperatures greater than 200° C. An organic-inorganic hybrid based on the present invention may be useful. The organic component may be monomeric, oligomeric or polymeric in nature and imparts additional toughness, plasticity and flexibility to the hybrid composition.

The present invention can be formulated to impregnate fibers to form a rigid composite material. This desirable feature differentiates the invention from most materials, because most rigid materials have not been processed as a low viscosity liquid capable of wetting fibers. Fiber reinforcement within a matrix material offer many benefits, including improved strength, stiffness, fracture toughness, fatigue, strength and impact resistance. While fiber-reinforced composite materials are common in applications ranging from automotive fascia to F-22 aircraft structures, the vast majority of composite materials are made with organic matrix materials, which are combustible. Non-combustible composite materials, such as ceramic matrix composite materials and metal matrix composite materials, tend to be cost prohibitive for most applications because of the high processing temperatures required. The present invention can be processed at much lower cost than most ceramic or metal matrix composite materials. These desirable features differentiate the present invention from many materials, including numerous metals.

The present invention readily can be formulated to incorporate a wide variety of the generally above noted fillers to tailor the material performance to suit the specific application. These fillers that may include hollow spheres, conductive fillers, friction and/or thermal additives, can be incorporated to modify physical properties including but not limited to density, conductivity, coefficient of friction, or thermal performance. These desirable features differentiate the present invention from many materials, including many metals. Given these features, the present invention is suited for many applications, including fire barriers, heat shields, high-temperature insulators, high-temperature molds, friction products, tooling and structures in high temperature environments.

In addition to the inorganic polymer matrix compositions, may other compounds may be utilized such as various organic and inorganic fillers, and the inorganic polymer matrix compositions can be fabricated by utilizing various processes such as compression molding, bulk molding, etc., and subsequently cured and treated and used in a wide variety of applications and have desirable properties according to numerous ASTM tests, all as set forth in U.S. patent Ser. No. 10/777,885, filed Feb. 12, 2004, for Fire Testing Inorganic Composite Structures, hereby fully incorporated by reference including all 39 examples thereof.

The fire-barrier systems, or multi-layer fire resistant systems of the present invention generally comprise two or more layers of a different material with preferably at least one of the layers comprising the above noted inorganic polymer matrix derived from an alkali silicate, and optionally, but desirably containing a fiber reinforcement therein. The remaining one or more layers comprise any of the following: at least one insulating material, at least one intumescent material, at least one foam material, at least one reflective material, or a reinforcement layer, or a reinforcement material in any of the above layers. Additionally, a corrugated gas containing layer can exist separately, or within any of the above layers. Still another fire-barrier system comprises two or more layers of the alkali silicate polymer resin.

Insulation materials which have good fire-barrier properties generally include high temperature resistant materials known to the literature and to the art such as various silicate compounds, various alumina compounds, or combinations thereof such as alumina silicates, (RCF). Often such compounds are in the form of fibers since they are of low weight and have many applications but solid layers of the same can also be utilized. Other suitable insulation materials include various minerals or compounds known to the art and to the literature which generally contain high amounts, (at least about 30%, or about 50% or about 70% by weight) of alumina, silica, aluminate, silicate, as well as other metal oxides therein containing calcium, magnesium, and the like. Still other insulation compounds include various refractory type materials such as silicon carbide, carbon-carbon, and the like. Various ceramic materials known to the literature and to the art can also be utilized as made from various clays, for example tile, terra cotta, and the like, porcelain, porcelain enamels, lime, plaster, and gypsum products, and the like.

The intumescent layer is generally any material which evolves a volatile, e.g. water, during heating at a time when the material's structure will support cell formation. Exfoliated graphite being highly preferred. Other compounds include the various alkali silicates such as sodium, potassium, or lithium silicate, or alkaline earth silicates such as calcium or magnesium silicate. Vermiculite is another useful intumescent.

The reflective layers are naturally composed of materials which reflect light and thus radiate heat away from the non-fire side of the system. The layer may be thick but preferably is thin and is made of a high-temperature resistant material. Suitable reflective materials generally reflect at least about 50%, or at least about 65%, and desirably at least about 80% or at least about 90% of sunlight incident thereon. Examples include polyester film such as Mylar®, aluminum foil or sheeting, and the like. Higher temperature resistant reflective surfaces generally include highly reflective metals and alloys such as titanium, chrome, nickel, and the like, stainless steel, and the like. The reflective surfaces are generally in sheet form and exist on the interior or the exterior of the laminate or multi-layer fire-resistant system.

Reinforcing materials have been described herein above and hence will not be repeated. While generally utilized in fiber form, either continuous our discontinuous, woven or non-woven, they can also be utilized in sheet form, or perforated sheet form, strips, and the like, and thus form an individual or separate layer. Desirably, as noted above, the reinforcing material is generally used in fiber form to reinforce the inorganic resin composite layer of the present invention. However, the various above-noted reinforcing materials, whether in sheet form or perforated sheet, or in any other form such as fibers, can be utilized to reinforce any of the above-noted layers such as an insulation layer, an intumescent layer, a foam layer, and even a reflective layer, to impart strength and structural integrity thereto.

The corrugated layer generally has numerous confined gas domains such as air therein to act as a fire resistant media within any of the above layers with the exception of the surface of the reflection layer. Thus, the above noted various insulation materials, intumescent materials, and reinforcing materials can have pockets of air or other gas therein. Alternatively, the corrugated layer can be a gas (e.g. air) layer between the insulation layer.

Cellular or foamed materials, such as foamed compositions, which can be used in the present invention are generally nonflammable and useful for thermal management, fire protection and other high temperature applications. The capability of the present invention to withstand temperatures beyond 800° C. allows its use in applications that cannot be met by organic-based foamed materials and/or its derivatives. Inorganic cellular materials, such as foamed compositions, made from carbon, glass or ceramic materials, can resist similar temperatures but are costly limiting their use for large scale thermal management needs and/or cost sensitive applications. Cellular materials prepared for the present invention can also be molded into complex as well as simple shapes as required and/or specifically shaped using traditional machining equipment. Cellular materials, such as foamed material can be either structural (integral) or nonstructural, formed with or without the use of a foaming agent. A syntactic foamed material can also be prepared utilizing the present invention and the appropriate fillers such as microspheres, microballoons and/or microcapsules.

In the preparation of the various types of barrier or multi-layer composites systems, generally one or more outer layers are made with a material which has good resistance to flame and burn through such as the inorganic polymer matrix derived from an alkali silicate, or one or more of the inorganic based materials such as the oxide-based cements, refractory materials, oxides of aluminum, and the like. The multi-layer flame-resistant systems optionally may contain an intermediate layer located between one or more outer layers and one or more core layers. The core layer can be a substrate sought to be protected such as a low melting point metal or a flammable material such as wood, or other organic material. Alternatively, in aesthetic applications, the aesthetic outer material such as wood, or a wood veneer surface, a plastic surface, etc., such as in a fire door, can contain intermediate or core layer(s) such as insulation layer, the alkali silica layer, to impede or prevent fire or heat penetration.

The various above-noted combinations of layers to form different types of laminates can be referred to as hybrid laminates or hybrid systems which can be made by joining, via lamination, etc., a fireproof inorganic lamina or laminate to an organic composite core. The fireproof composite functions as a fire barrier, an oxygen barrier, and to a lesser extent insulation. Unlike typical passive insulation, the fireproof composite does not function mainly as an insulation that prevents heat from decomposing the organic resin. Instead, the fireproof inorganic resin acts as a flame and oxygen barrier.

A multitude of systems or multi-layer composites can be made utilizing, in any order, one or more layers comprising the inorganic polymer matrix derived from an alkali silicate such as reacted with a non-silicate network former and/or a reactive glass, water, an optionally one or more secondary network modifiers; and at least one layer of any of the following layers, an insulation layer, an intumescent material layer, a foam layer, a reflective layer, a reinforcing layer, or a corrugated layer; preferably with one or more of any of the above layers containing a reinforcing material such as generally a fiber, etc., therein. The number of layers of the fire resistant laminates or systems of the present invention can vary widely such as generally from about 2 to about 10 layers, and typically or preferably from about 2 to about 3, or about 4, or about 5 layers, or about 7 layers.

The alkali silicate resins or composites thereof, e.g. containing rein-forcing materials, can be utilized in many ways in creating systems whose purpose is to increase fire resistance or to create a fire barrier capable of preventing flame penetration, oxygen penetration, thermal insulation (orders of magnitude less then steel) and strength retention during and after the fire exposure (level of retention dependent on fire temperature and time). For example, an alkali silicate resin layer as thin as 0.020 inches to thicker structural laminates can be used as fire barriers over organic composites or wood to improve the systems fire resistance. These properties can be further optimized for more demanding fire protection scenarios with the incorporation of high temperature insulation that comes in a variety of forms. The combination of an alkali silicate resin layer or composite thereof and insulation addresses various shortcomings of high temperature insulation materials alone. A thin non-structural layer (0.020″) can improve durability, reduce convention heat transfer and act as an oxygen barrier. These systems can then be used as passive fire protection for substrates such as wood, steel or composite materials. Multiple layers of an alkali silicate resin layer or composite thereof and insulation can be engineered to create better performing fire systems for not only fire requirements but physical, mechanical and thermal requirements, which are important considerations in most fire system designs. Incorporating reflective surfaces on the interior or internal alkali silicate resin layer or composite thereof will further improve the systems performance by reducing the radiate heat conduction. Using thicker alkali silica resin or composites capable of maintaining structure alone or with a rigid non-flammable insulation core can function as a load bearing structure, which are completely non-flammable. Rigid non-flammable insulations capable of being a core for a structural sandwich construction are not common with the better performing insulations being expensive and hard to use. Various foams offer a good insulation core capable of good adhesion to alkali silicate resin face sheets and good performance.

Fire protective systems are designed based on fire protection requirements, allotted envelope for the system, mechanical requirements, physical requirements and depending on the market, cost. Some fire barriers can be a simple 0.020 inches thick alkali silicate resin layer or composite thereof with the purpose of preventing flame penetration (alkali silicate resin layer/Carbon laminate—2 ply used for fire protection of nacelles). Other systems can consist of multiple layers intended to insulate, prevent fire penetration and maintain a low cold side temperature for a long duration (a VSV material), i.e. an alkali silica resin layer having a reinforcing metal screen and outer layers of glass was used as the cover layer over ceramic blanket to reduce convention heat transfer and make the system more durable. Also a VSV multi-layer system in fire door cores can be used to create an envelope for the intumescent to expand into, reduce convention heat transfer and to impart strength to withstand a hose stream test. Fire-barriers function by a variety of mechanisms; eliminating fire penetration, preventing oxygen penetration from combusting the underlying flammable material and reducing the heat needed for combustion. Fire protective systems can become very complicated based on heat transfer, combustion of materials, strength retention during and after the fire and material, physical and thermal properties of the system in the ambient condition.

An alkali silicate resin layer or composite thereof is useful in fire barriers either alone or as part of a system including insulation and/or reflective surfaces. The 90 minute wooden fire door application uses a VSV system (i.e. vail/screen/vail multi-layer system) in combination with an intumescent material to protect the wooden cold side panel for 90 minutes of ASTM E-119 fire exposure and then to survive a hose stream test. The door core fire barrier is only ⅝″ thick before exposure representing the thinnest 90-minute fire core presently available on the market. Another fire-barrier system representing a much simpler system is a 2-ply alkali silica resin/Carbon reinforced composite used as fire protection in jet engine nacelles to prevent fire penetration. This application besides having a fire protection requirement also needs to be vibration resistant and chemical resistant.

Alkali silicate resin composite's uniqueness is the materials, non-combustibility, low thermal conductivity, high temperature properties, low temperature processibility and low cost. In combination these attributes represent a unique material capable of being used in a wide variety of applications. Competitive materials do exist but not with all the attributes offered by the alkali silicate resin composite materials.

Laminates, or multi-layer fire-resistant systems containing at least one layer, made from the fireproof inorganic resins of the present invention, can be used to protect organic based substrates, laminates items, etc., from fire for a given time interval. The inorganic resin system is unique in that it does not rely on insulating the organic laminate from heat. Instead, the resin functions as a fire/oxygen barrier to address different corners of the fire triangle. Acting as a fire/oxygen barrier, these fireproof inorganic layers do not prevent the organic material from decomposing, only combusting. Thus, using a hybrid laminate to improve the performance of an organic laminate can be accomplished as long as attention is paid to the method by which the core material is insulated.

While various utility and end uses are set forth hereinbelow, important multi-layer, fire-resistant, systems include an alkali silicate resin composite per se, a VSV system, and fire doors. The composite per se is utilized in almost all applications and includes the modified inorganic polymer matrix made from an alkali silica, one or more non-silica network formers, and/or a reactive glass, and optionally one or more secondary network linking units, all commonly referred to as an alkali silicate resin. It is an important aspect that the resin contains a reinforcement therein generally in the form of a reinforcement fibers such as carbon fibers. In order to achieve appropriate thickness and structural integrity, two such layers of the alkali silica resin composite can be used and can simply reside upon one another, be fused together, or adhered to one another, or attached in any manner.

The VSV system generally contains metal reinforcing element such as a screen, perforated sheet, etc., is utilized and is embedded within the alkali silicate resin to form a composite. On either side of the one or more layers of the composite, a thin glass insulation layer is utilized. This multi-layer system finds use in several applications such as on the inside of ship hulls.

The fire door embodiment generally utilizes an alkali silicate resin composite containing fibers therein with an intumescent layer generally on both sides thereof, all located within wood paneling, etc. to form a wood fire door. Additional layers of the inorganic alkali silicate resin composite and the intumescent layer can be utilized depending upon the degree of protection sought.

The various laminates, or multi-layer systems of the present invention can be applied to a wide variety of applications such as reinforced missile silos, ship decks, aircraft carrier blast and heat shields, fire barriers, hot gas filters, protective coatings, electrical panels and boxes (with and without EMI shielding), engine covers, or any application that would need, advantageously, protection from fire and heat transfer damage, corrosion resistance, lifecycle cost savings and weight reduction. Additionally, this technology can be applied to reinforce insulator inserts for aircraft brakes. The insulator within each piston thermally isolates the friction head from the hydraulic system. Compared to conventional resins, some of which decompose below 450° C., the matrix binders of the present invention have much higher thermal stability (to above 1000° C.), and in contrast to metals, the composite of the present invention has superior insulation performance. This protects the hydraulic system and can reduce the weight and/or associated costs. In comparison to ceramics, the composite of the present invention is tougher because due to the presence of the reinforcing fibers, but less expensive than ceramic matrix composites due to the materials and processes utilized.

The barrier systems of the present invention can also be used in those applications where good thermal and physical stability are desired, such as those applications for which ceramic composites are used. Applications would include uses in aerospace, marine, mass transportation, structural, and architectural applications, ranging from simple applications requiring fire resistance and/or thermal resistance to more sophisticated fire proof applications, including high temperature and long duration protection, heat and fire protection for conduits, cable trays, electrical transmission lines, gas and oil pipelines, fire and heat protection for structural steel columns, beams and open web joists, and bulkheads and other surfaces for boats, ships, aircraft, buses, cable cars, trolleys, and the like. Applications can achieve fire protection for 60 or 90 minutes or more at a temperature of up to 1700° F., and can do so with relatively light weight structures.

In accordance with the concepts of the present invention, Table 1 serves as a sample illustration of the various different types of barrier systems which can be utilized according to the present invention.

The following Table 1 is presented as illustrative of applications for the present invention, but are not considered to be exhaustive of or limiting the uses for the invention:

TABLE 1

| | | Structure | | |
|---|---|---|---|---|
| | | (Composite = Reinforced | Inorganic | |
| | | Inorganic | Laminate | |
| Example | Application | Resin Composite) | Materials | Comment |
| A | light weight fire | Inorganic Composite | Carbon fiber/ | Thickness can |
| | stop or barrier | | alkali silicate | range from 1 ply to |
| | | | resin | multiple |
| B | Thermal/Fire | Inorganic Composite/ | Carbon or | Core can be |
| | barrier- | Insulation/Composite | glass fiber/ | insulative materials |
| | light weight; low | | alkali silicate | including |
| | cost | | resin | honeycomb |
| C | Thermal/Fire barrier | Wood/ | Stainless | Layers can be |
| | Door structure | Inorganic Composite/ | steel fiber/ | optimized for |
| | meeting 90 minute | Intumescent Mat/ | alkali silicate | performance |
| | test | Inorganic Composite/ | resin | |
| | | intumescent Mat/ | | |
| | | Inorganic Composite/ | | |
| | | Wood | | |
| D | Thermal/Fire barrier | Intumescent coating/ | Glass or | Provides fire and |
| | for Marine | Inorganic Composite/ | stainless | thermal barrier |
| | application | 8 lb Mineral | steel fiber/ | |
| | | blanket/Bulkhead | alkali silicate | |
| | | structure | resin | |
| E | Fire Barrier | Corrugated Inorganic | Fiber/alkali | Composite is |
| | Incorporating air | Composite | silicate resin | molded as a |
| | spaces | | | corrugated material |
| F | Organic Composite | Inorganic Composite/ | Fiber/alkali | Adds fire resistance |
| | having improved | Organic Composite/ | silicate resin | and improved |
| | fire resistance | Inorganic Composite | | strength to organic |
| | | | | composite |
| G | High level thermal | Inorganic Composite/ | Fiber/alkali | Foam can be glass, |
| | and fire resistant | Inorganic foam/ | silicate resin | carbon, and the like |
| | performance | Inorganic Composite | | fireproof foam |
| | material | | | systems |
| H | Higher strength fire | Inorganic Composite/ | Composite is | Mineral core is |
| | barrier | Mineral Core/ | of stainless | known fire core and |
| | | Inorganic Composite | steel fibers/ | composite improves |
| | | | alkali silicate | fire barrier |
| | | | resin | performance |

Still other examples of suitable laminates or systems include Examples 1 through 8 of Table 2 wherein the material type “composite” is an inorganic polymer composite containing an alkali silicate resin and a reinforcing material.

TABLE 2

| Example | Layer | Material | Material Type | Advantage | Comments |
|---|---|---|---|---|---|
| 1 | 1 | FR/C | Composite | light weight fire stop/barrier | thickness can range |
| | | | | | from 1 ply to |
| | | | | | multiple |
| 2 | 1 | FR/C (or G) | Composite | Thermal/Fire Barrier | Core can be any |
| | 2 | Balsa | Insulation | light weight low cost | insulative material |
| | | | (wood) | | including |
| | 3 | FR/C (or G) | Composite | | honeycomb |
| 3 | 1 | MDF | Wood | Thermal/Fire Barrier | Layers of FR/SS and |
| | 2 | FR/SS | Composite | Core | Palusol can be |
| | 3 | Palusol | Intumescent | Thin 90 min door | optimized for any |
| | | | mat | | performance |
| | 4 | FR/SS | Composite | Core | |
| | 5 | Palusol | Intumescent | | intumescent mats |
| | | | mat | | can be any of many |
| | 6 | FR/SS | Composite | | types |
| | 7 | MDF | Wood | | |
| 4 | 1 | Coating | intumescent | Thermal/Fire Barrier | System is being |
| | | | coating | | evaluated for the US |
| | 2 | FR/G (or SS) | Composite | Superior Performance | Navy |
| | 3 | Blanket | 81b mineral | vs. twice as much blanket | |
| | | | blanket | | |
| | 4 | Steel | Bulkhead | | |
| | | | structure | | |
| 5 | 1 | FR/Any | Corrugation | Air spaces improve thermal | Any means of |
| | | | | performance | generating air |
| | | | | | spaces works - can |
| | | | | | be easily optimized |
| 6 | 1 | FR/Any | Composite | FyreRoc - Fire Barrier | FyreRoc composite |
| | 2 | RP | Organic | Improving Fire performance | improves strength |
| | | | Composite | of any Organic Composite | and fire performance |
| | 3 | FR/Any | Composite | | of organic laminate |
| 7 | 1 | FR/Any | Composite | High level of thermal | Foams can be glass, |
| | | | | insulation and fire | carbon, etc. With |
| | | | | performance | the correct foam |
| | 2 | Foam | Inorganic | Insulation and fire | can be Fire Proof |
| | | | foam | performance | System |
| | 3 | FR/Any | Composite | performance | |
| 8 | 1 | FR/SS | Composite | Improve the strength after | Mineral core is |
| | | | | fire of the mineral core | known fire core - |
| | 2 | Min. Core | Mineral Core | | FR/SS improves on |
| | 3 | FR/SS | Composite | | inherent weakness |

Material Code

| | |
|---|---|
| FR = | Inorganic polymer matrix derived from alkali silicate |
| C = | Carbon Fiber |
| G = | Glass |
| Any = | Any Fiber |
| SS = | Stainless Steel Fiber |
| MDS | Medium Density Wood |
| RP = | Reinforced Plastic |

As apparent from Tables 1 and 2, many different types of laminates or structures can exist composed of at least one inorganic polymer layer comprising an alkali silicate material and other layers such as any of at least one insulation layer, intumescent layer, foam layer, corrugated layer, reinforcing material layer, and the like.

The resulting composites exhibits dimensional stability up to about 900° C. and higher, depending upon the final formulation and chosen processing and possesses excellent properties with respect to flame, smoke and toxicity. A composite made using the inorganic resin composition of the present invention is lightweight with good thermal insulating characteristics. Various shapes are relatively inexpensive to manufacture primarily due to the low temperature and pressures needed to affect cure of the composite.

The inorganic resin compositions are useful as fire proof binders, bulk molding materials, sheet molding compositions, adhesives, coatings, neat resin compositions, cellular materials, such as foamed compositions or fire resistant composites. As composites, the inorganic resin composition can be formed into shaped objects when cured. Alternatively, as a composite, the composition is used to impregnate a fabric, which may be combined with other similarly impregnated fabrics to form a lay-up, which in turn is then shaped and cured to form a shaped composite or object, similar to a bulk material, but with the benefit of the reinforcement provided by the fabric. The compositions of the present invention are useful in those applications where good thermal and physical stability are desired, such as those applications for which ceramic composites are used.

When using unidirectional fiber, the new fireproof inorganic resins have mechanical properties comparable with organic resin composites. Woven fabrics composites using the resin system are a little more problematic due to the difficulty in penetrating the fiber bundles. However, the FST performance of the inorganic system with an organic based structural component is believed to provide some mitigation.

Thermal properties consisting of thermal conductivity, thermal expansion and specific heat have been evaluated for glass, stainless steel and carbon reinforced fireproof inorganic resin composites. The thermal performance evaluated by these methods showed consistent performance for new fireproof inorganic composites from room temperature to 800° C.; impossible with organic resin systems.

The composites can also be laminated, using standard lamination techniques such as inorganic high temperature adhesion or high strength organic adhestion depending upon the required properties of the system. In addition, hybrid composites can be made by joining, via lamination, a fireproof inorganic composite or laminate to an organic laminate or composite core. The fireproof composite or laminate functions as a fire barrier, an oxygen barrier, and to lesser extent insulation. Unlike passive insulation, the fireproof composite does not function mainly as an insulation that prevents heat from decomposing the organic resin. Instead, the fireproof inorganic resin composite acts as a flame and oxygen barrier. In addition, the fireproof composite improves the strength of the hybrid composite.

Composites, made from fireproof inorganic resins, can be used to protect organic based composites and laminates from fire for a given time interval. The inorganic resin composition used to form the composite is unique in that it does not rely on insulating the organic composite from heat. Instead, the inorganic resin composition functions as a fire/oxygen barrier to address different corners in the fire triangle. Acting as a fire/oxygen barrier, these fireproof inorganic layers prevent combustion but not decomposition. Thus, using a hybrid composite to improve the performance of an organic composite can be accomplished as long as attention is paid to the method by which the core material is insulated.

The fire resistant composite alone or with core materials can be employed, for example, with wooden panels to make a fire resistant door. The fire-barrier composite can be used alone as a barrier or it can be formed with air spaces such as corrugations, honeycomb or hollow spheres can added to the inorganic resin composition to enhance the fire resistance performance, improve insulation performance, or structural performance without the addition of a core material. Further, the fire-barriers composites can be employed with single cores or multiple core constructions to improve a variety of properties. The fire-barrier composite can be applied or joined with any substrate which needs improved fire resistance such as by being further laminated to other substrates which are not fire resistant to enhance the performance of the total composite. Additional structural support can be added to the structure such as for example, but not limited to wire mesh, metal screens, glass screens, etc. The invention can be applied to any structure that serves as a fire barrier, although its use in fire doors exemplifies the benefits. Since the inorganic fire resistant composites are designed to allow the barriers, such as doors, to pass the hose stream, and to maintain the cores protective envelope without being weight prohibitive the core can now meet performance properties not previously possible without the inorganic fire-barrier composites. The barrier composite weight vs. its strength is important in fabricating a fire barrier. As noted, thinner barriers which weigh less, while meeting the 60 and 90 minute fire ratings, will allow for the barriers to be used in more architectural applications.

The laminates or barrier systems of the present invention were tested with respect to two major types of methods. The first method is flammability testing which is used to measure the fuel component part of the fire triangle for the material being tested. Flammability testing is described in various ASTM (American Society for Testing and Materials), NFPA (National Fire Protection Association), IMO (International Maritime Organization), ISO International Standards Organization), UL (Underwriters Laboratory) and other standards protocols for measuring time to ignition, flame spread, heat release and tenability (smoke). These tests are used to characterize the material for FST performance. Organic composites that are modified to have good fire properties will normally do so at the expense of other properties in the system.

The second method exposes the material to the approximate temperature curve that an actual fire would generate. In this type of testing the material is exposed to the fire curve for a given time after which the material is evaluated based on how well it survived the exposure. Two common fire curves are normally used: ASTM E-119 and UL-1709. ASTM E-119 is intended to follow the temperature profile of a building fire and is used in evaluating most building construction products. The ASTM E-1119 fire curve is designed to mimic an actual building fire and is used with a variety of failure criteria to determine the endurance of a given part during a fire. Based on a given thickness, wooden parts will survive in an E-119 fire scenario for 20 or more minutes in certain cases. To improve the fire performance, for example, the wood can be sandwiched between fireproof insulation or a fire-barrier/insulation can be used between two layers wood. Time periods are measured in 30, 45, 60, and 90-minutes after subjecting the sample to a particular surface temperature. UL-1709 follows the temperature profile of a fuel fire and is used for aerospace and military products. In the case of an I-beam evaluation, the failure criterion is the incidence of complete structural failure.

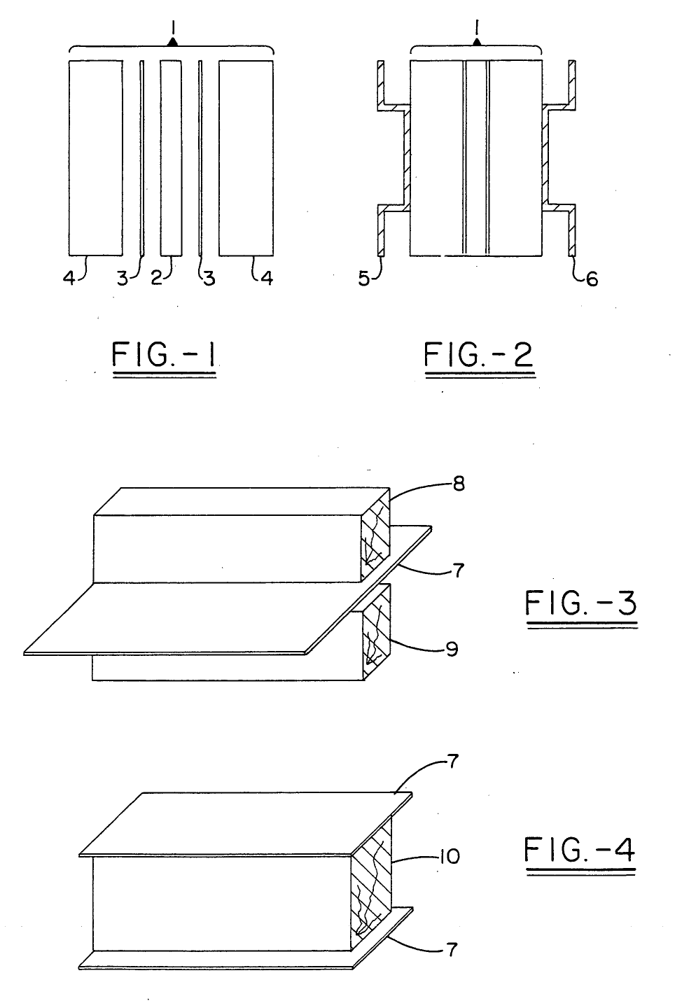

FIG. 1 illustrates an example of a laminate that can be made in accordance with the present invention. As shown, the laminate assembly 1 could be, for example, a door or a barrier. Laminate 1 is formed from a layer of intumescent material 2, having layers of alkali silicate resin 3 laminated on either side of the intumescent layer, and having outer layer 4, which could be wood or other materials to provide a desired architectural appearance. Further, as is shown in FIG. 2, additional surfacing could be added by joining or laminating a shaped metal front 5 and back 6 to the exterior layer 4 of laminate 1.

FIGS. 3 and 4 illustrate two common fire resistant assembles for improving the fire resistance of wood. As shown in FIG. 3, a fire resistant laminate 7 is laminated between two wood structures 8 and 9. In FIG. 4, the fire resistant laminates 7 are applied to the surface of a wood structure 10.

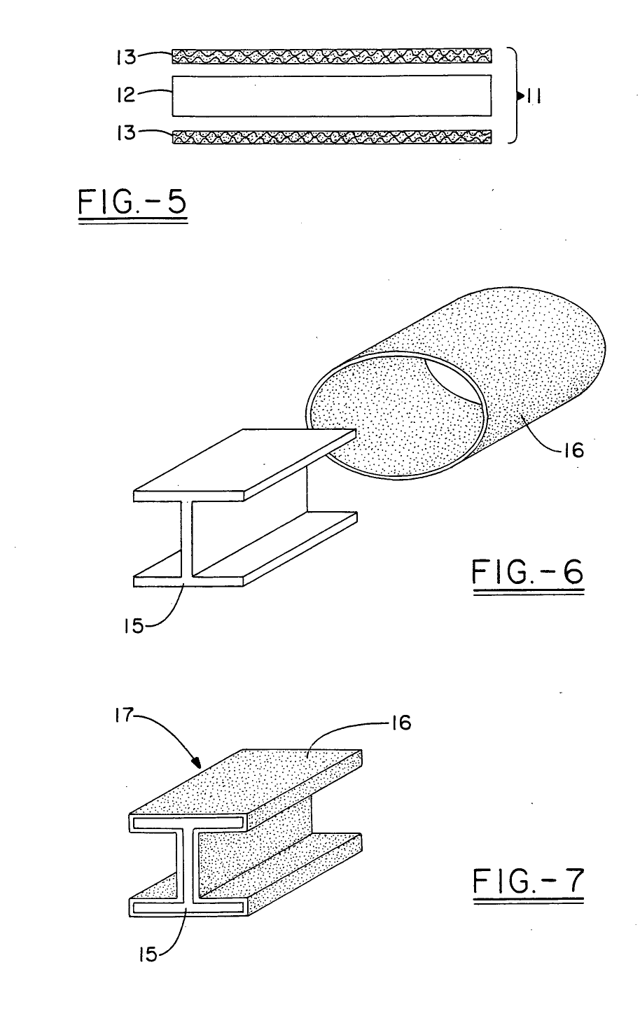

FIG. 5 illustrates a hybrid laminate 11 in which an organic composite core 12 is joined to or covered by fire resistant laminates 13. The core 12 could be, for example, an epoxy or phenolic composite or laminate, while the fire resistant laminates 13 could be, for example, a non-woven fiberglass mat which has been impregnated with an alkali silicate resin. The mat could be a single layer or a laminate of more than one layer depending upon the performance needs or desired configuration.

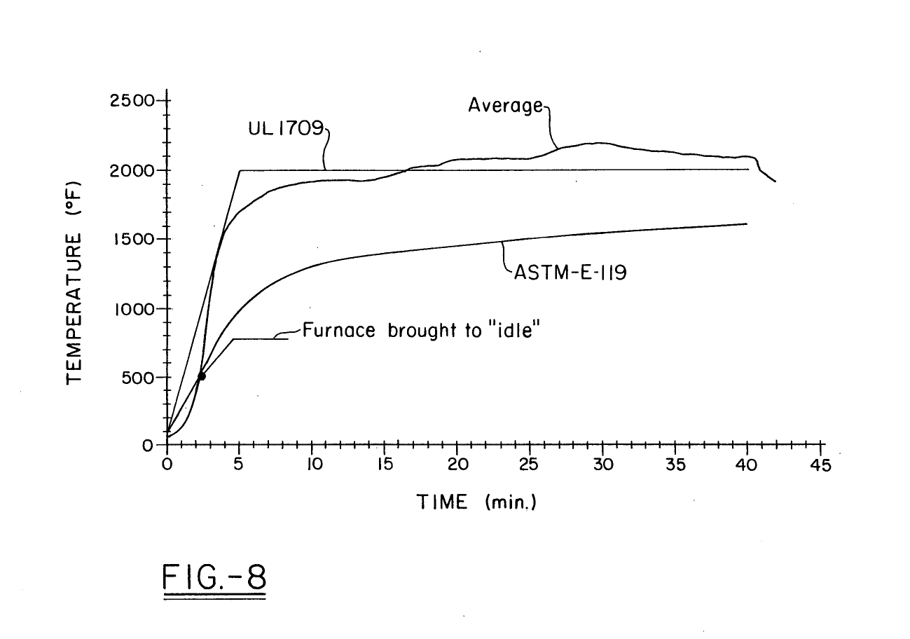

FIGS. 6 and 7 illustrate yet another configuration embodying the concepts of the present invention in which a structure such as an I-beam 15 has a sleeve of fire resistant laminate, such as for example, a non-woven glass fiber mat impregnated with an alkali silicate resin in accordance with the present invention, placed over the beam and molded to the beam to produce a fire resistant I-beam 17 shown in FIG. 7.

To further understand the invention, a number of composite laminated structures were made and evaluated for their performance as fire resistant materials. Cores were manufactured from fireproof inorganic resin represent a material with the dual capability of acting as both a fire block and a structural member after the fire. The insulating characteristics of the new core system are much better then steel (2.5 BTU in/hr ft2 F vs. 325 BTU in/hr ft 2 F thermal conductivity). In order to be insulative enough to meet the E-119 cold side testing protocols, intumescent materials were added to the core structures. The intumescent material used in test panel construction functions an insulator as well as a heat sink. The material expands during the fire test, which results in the cold side temperature remaining below the ignition temperature of the wood. The cold side wood layer can then remain structural to withstand the hose stream test. The disadvantage of an intumescent material is that as the fire duration is increased, it's effectiveness as insulation is decreased to a point where the cold side material will decompose. The cold side wood will then no longer withstand the hose stream test.

The fireproof laminates evaluated consist of an inorganic resin (alkali silicate resin) pre-impregnated into stainless steel mats compression molded from 27° C. to 66° C. The mats consisted of two layers, on 0° and one 90° needled together into a single ply. The porosity of the mats results in approximately 80 vol % resin in the finished product. The resulting laminate is 0.102 cm thick with a density of 2.5 gms/cm³ (Inorganic laminate “A”). Additional fireproof laminates consist of fire resistant inorganic resin impregnated into glass fabric resulting in a thickness of 0.064 cm and a density of 1.90 gms/cm³ (Inorganic laminate “B”) and fireproof inorganic resin impregnated into a glass fiber mat resulting in a thickness of 0.089 cm and a density of 2.3 gms/cm³ (Inorganic laminate “C”).

The systems evaluated in this investigation essentially consisted of two layers of wood sandwiching a fire barrier. The fire barriers tested were both single component material systems and sandwich systems. Variations in the fire barrier tested were incorporated to optimize the fire performance for the total system. The various constructions had different levels of insulation and fire barrier laminates so that these two variables could be evaluated versus the system's performance. The intumescent material used was 0.318 cm thick with an expansion ratio of 4 to 1 during heating. All samples were approximately 4.45 cm thick. The wood used in the evaluation was medium density fiberboard (MDF), although high density fiberboard (HDF) could have been employed as well. The thickness of the wood ranged from % inch in the thick sections to ¼ inch in the thin sections where the door was machined for added style. The total thickness of the door was 1% inches with the core allowing one inch to be machined off of ½ inch per side. The core thickness of the 90 minute door was approximately ¼ inch thick. The samples evaluated were as follow:

The first furnace charge consisted of:
I. a wood panel used as a control sample,
II. a wood layer/fire resistant laminate “A”/wood layer sandwich sample,
III. a wood layer/intumescent layer/wood layer sandwich sample, and
IV. a wood layer/fire resistant laminate “A”/intumescent layer/fire resistant laminate “A”/wood layer sandwich sample.

The second furnace charge consisted of:
V. a wood layer/fire resistant laminate “A”/intumescent layer/fire resistant laminate “A”/wood layer sample,
VI. a wood layer/fire resistant laminate “B”/intumescent layer/fire resistant laminate “B”/wood layer sample,
VII. a wood layer/fire resistant laminate “C”/intumescent layer/fire resistant laminate “C”/intumescent layer/fire resistant laminate “C”/wood layer sandwich sample.

The fire testing was performed at Southwest Research Institute on test panels 61 cm by 61 cm. Using the originally identified E-119 fire curve, it was observed that the heat emanating from the burning wood was in excess of the original curve. In order to collect more usable data the temperature was compared to an UL-1709 curve, which more closely approximated the observed behavior (FIG. 8). In the case of this study, a surface temperature of 232° C. was used.

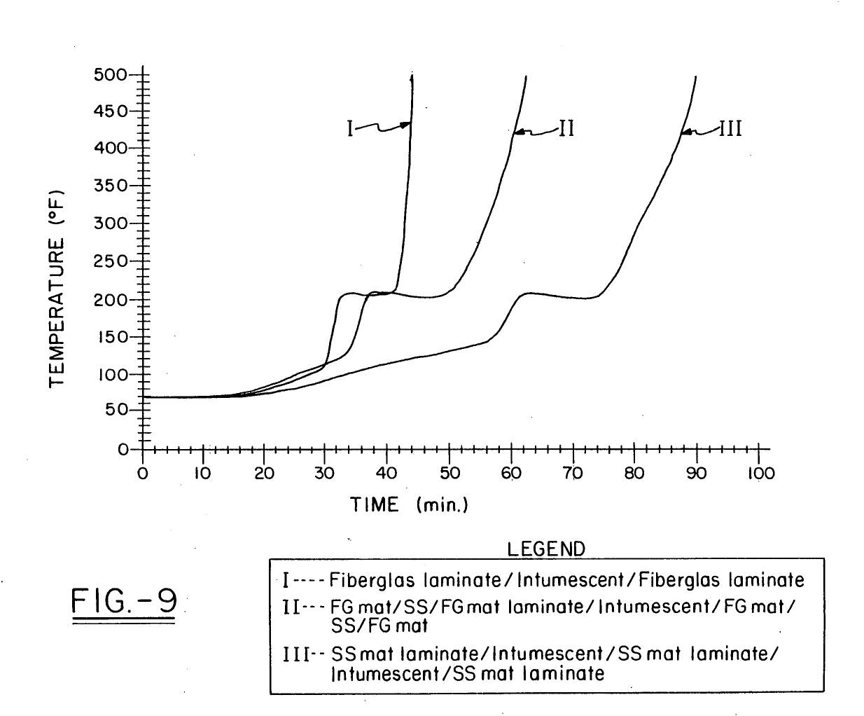

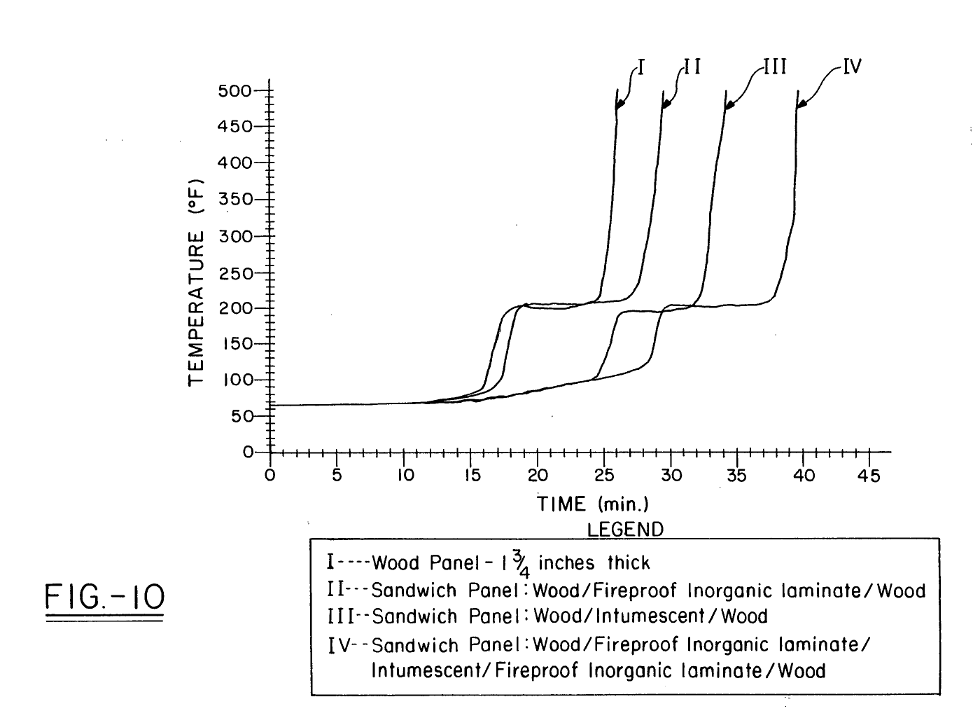

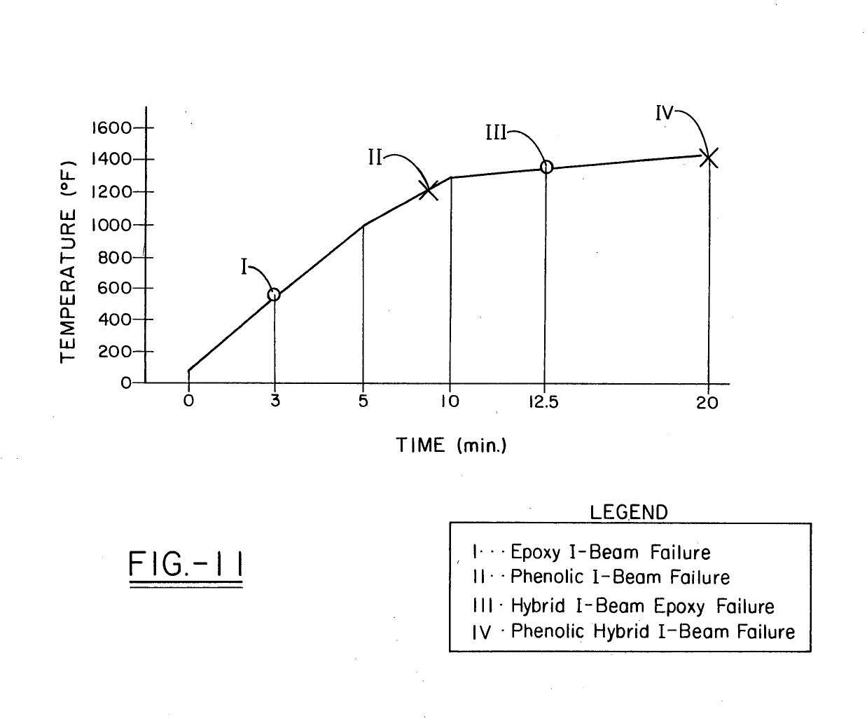

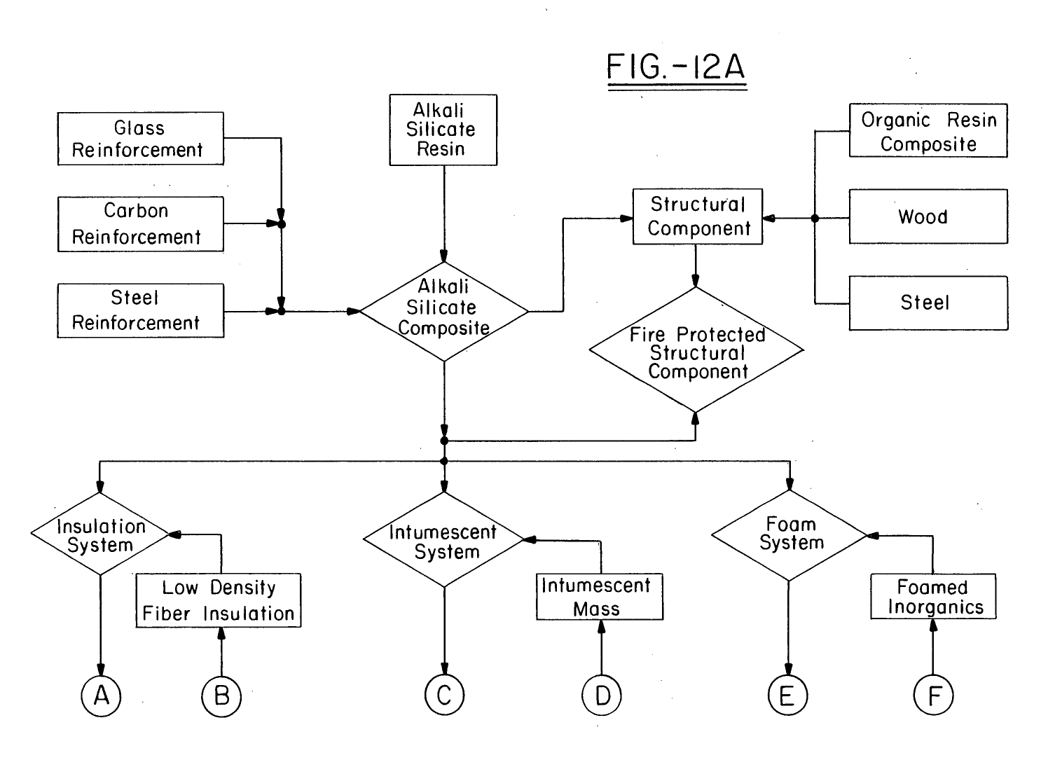

Thermocouples were used to monitor the internal temperature and cold face temperature at multiple points on the test panel. The testing was performed on four panels per furnace run. The test procedure was run until every panel in the test had failed. Panel failure is indicated by the point in time when fire penetrates the sample. The results are summarized in FIGS. 9 and 10.

During the first furnace run, the core-less wood sample was observed to fail in 25:45 minutes. The wood with a Fire resistant laminate core failed at 29:00 minutes, intumescent core failed at 32:45 minutes and the sandwich of Fire resistant laminate/intumescent/Fire resistant laminate failed at 39:00 minutes.

The fireproof inorganic core functions as a fire and vapor barrier during the fire and as a structural material after the fire is extinguished. As a structural component, the core allows the wood to degrade during the fire test and still withstand the hose stream test. The fireproof inorganic core also keeps the intumescent in place during the later stages of the fire exposure and reduces the rate of water vapor evolution during the fire. Thus, the synergistic effects of the sandwich core of intumescent and fireproof inorganic laminates offer a substantial advantage over either material alone. Further, the intumescent material expands between the restraining layers of the inorganic laminate rather than expanding isotropically as would be the case with an unrestrained intumescent sheet.

The use of fireproof inorganic cores along with an insulating material meets E-119 testing protocols up to 90 minutes long in applications requiring retention of strength after the fire exposure. The results for samples observed in the second furnace run demonstrated the performance of the inorganic resin/glass fiber versus inorganic/stainless steel fiber cores. Testing demonstrated the glass fiber laminate to fail approximately 12 minutes sooner then the laminate containing the stainless steel screen. It is believed that the low thermal properties of the glass/fire resistant laminate and the loss of strength versus temperature compared to the stainless steel reinforced samples are the reasons for the difference in performance. The sample with three layers of fire resistant laminate and two plies of intumescent improved the time to failure by 50 minutes over the fire resistant laminate/intumescent/fire resistant laminate. The data indicates that the fire resistant laminate, 0.040″ thick, can improve the time to failure for a combustible wood material. Insulating the wood is not responsible for the improvement in performance. Instead, the results are thought to be caused by the laminate acting as an oxygen barrier and slowing combustion. The combination of fire resistant laminate/intumescent/fire resistant laminate core gave the result one would expect from the data generated on the fire resistant laminate alone and the intumescent material alone. The improvement seen during the use of the intumescent core is believed to be a function of its ability to insulate the wood. Thus, the combinations of fire resistant laminate and intumescent performed as expected. The additional 20 minutes before sample failure would indicate a synergistic effect from having multiple intumescent and fire resistant layers in the core.

A core consisting of multiple layers of fire resistant laminate in combination with multiply layers of an intumescent material measuring 0.953 cm thick incorporated into 4.45 cm thick processed wood panel can meet a 90 minute ASTM E-119 test. Fire resistant laminates, made from fireproof inorganic resins, is unique in that it functions as a fire/oxygen barrier to address different corners in the fire triangle. Acting as a fire/oxygen barrier, these fireproof inorganic layers do not prevent the organic material from decomposing, only combusting. Because insulating the “cool side” of wood panels from heat in important in gaining an ASTM E-119 rating, insulating functionality is enhanced through the use of an intumescent layer. Further, the intumescent material expands between the restraining layers of the inorganic laminate rather than expanding isotropically as would be the case with an unrestrained intumescent sheet.

As a further example, a hybrid composite lamination was evaluated. The materials used consist of organic composite structures supplied by Electric Boat Corporation (EBC) and inorganic composites supplied by Goodrich Corporation. The inorganic resin composite was developed to meet MIL-STD-2031 in thermal management applications. The hybrid flat panel laminate consists of an organic resin composite sandwiched by two layers of the inorganic resin composite. Flammability testing on the epoxy composite system was done with fireproof inorganic laminates having a varied thickness as will be discussed further hereinafter.

In addition to the flat panel hybrid structures, I-beam hybrid samples were created and evaluated to approximate the performance of an actual grating to be used on a submarine. The I-beam hybrid samples were made by curing the inorganic resin composite to the abraded surface of the organic resin composite I-beam from either epoxy or phenolic composites. Both organic resin composite I-beams were made using pultrusion with stitched fabric reinforcements. The inorganic composite was made by impregnating a carbon fiber sock to go over the beam. The stock is a stitched fabric that can be impregnated then pulled over the I-beam to cover the I-beam surface. The fireproof inorganic laminate thickness was approximately 0.07 cm thick. Intensifiers were inserted into the I-beam to assure adequate pressure on the inside of the I-beam during curing. The hybrid composite beam was then vacuum-bagged and autoclave cured.

The first set of hybrid samples evaluated consisted of flat panel inorganic laminates of various thicknesses and they were evaluated as to their ability in protecting epoxy or phenolic composite laminates such as those shown in FIG. 5. Reinforcement types used in this evaluation were both glass and carbon impregnated with the inorganic resin. The test evaluated the effect of thickness and reinforcement type on fire performance. The test protocol selected was cone calorimetry, ASTM 1354, which is useful in determining time to ignition, heat release rates, peak heat release rates, and smoke generation. This test is conducted at heat flux measurements of 75 and 100 kW/m2 tests.

Flammability testing on the flat panel hybrid composite system was done with various thicknesses of carbon/epoxy or glass/epoxy composites protected with fireproof inorganic resin. All of the samples have the same thickness of flammable material. The flammability testing of the phenolic composite was done with only a 2-ply inorganic resin glass composite laminate. As shown in Tables 2 and 3, performance in all of these tests was very good.

TABLE 3
ASTM 1354 Data at Heat Flux of 75 kW/m²
System: Epoxy laminate core with Inorganic laminate facesheets

| | | Peak | Average | |
|---|---|---|---|---|
| | | Heat | Heat | Total |
| Material | Time to | Release | Release Rate | Heat |
| (Inorganic Laminate | Ignition | Rate | 5 min | Release |
| Construction) | (seconds) | (kW/m²) | (kW/m²) | (MJ/m²) |
| 1 Ply Carbon Fiber Mat | 117 | 271 | 151 | 57 |
| 2 Ply Carbon Fiber Mat | 166 | 244 | 155 | 62 |
| 4 Ply Carbon Fiber Mat | 221 | 203 | 123 | 56 |
| 8 Ply Carbon Fiber Mat | 306 | 186 | 110 | 63 |
| 1 Ply Glass Fiber Mat | 136 | 266 | 157 | 65 |
| 2 Ply Glass Fiber Mat | 137 | 230 | 145 | 55 |
| 4 Ply Glass Fiber Mat | 232 | 229 | 130 | 67 |
| 8 Ply Glass Fiber Mat | 302 | 195 | 81 | 61 |
| Neat Epoxy/Glass | 28 | 328 | 201 | 60 |
| Laminate | | | | |

TABLE 4
ASTM 1354 Data at Heat Flux of 75 kW/m² and 100 kW/m²
System: Phenolic laminate core with 2 Ply Carbon Inorganic Laminate

| | | | Average | |
|---|---|---|---|---|
| | | Peak | Heat | |
| | | Heat | Release | Total |
| Material | Time to | Release | Rate | Heat |
| (Heat Flux) | Ignition | Rate | 5 min | Release |
| (kW/m²) | (seconds) | (kW/m²) | (kW/m²) | (MJ/m²) |
| 2 Ply Carbon Laminate (75) | 255.12 | 40.14 | 25.74 | 11.19 |
| 2 Ply Carbon Laminate | 73.38 | 64.86 | 35 | 14.07 |
| (100) | | | | |
| Phenolic Composite | 163 | 64 | 48 | N/A |
| Laminate (75) | | | | |
| Phenolic Composite | 62 | 81 | 53 | N/A |
| Laminate (100) | | | | |

The second test protocol evaluated the fire endurance of the hybrid laminate using an I-beam. The beams are comprised of an epoxy or phenolic composite core protected with an inorganic composite surface (FIGS. 6 & 7). The exact protocol used in this test was derived to best evaluate the effect of the laminate on the endurance of the hybrid beam. Using an E-119 fire curve and testing protocol similar to MIL-G-18015B, this test mimics an actual fire scenario under load. During the fire test the I-beam spanned across a furnace with a 20 pound weight suspended from the beam and perpendicular to the length of the beam. As the test proceeded, the beam eventually burned resulting in the beam breaking.

As seen in FIG. 11, the test results show a substantial increase in temperature resistance and time to structural failure for the fireproof inorganic reinforced hybrid beams. Additionally, no smoke was observed to be present during the fireproof resin I-beam test.

The fireproof inorganic resin's performance in all of these tests gave the same results: non-flammable performance. This is due to the resin's design to not act as a source of fuel. It is the reaction of the flammable core as part of a hybrid laminate with non-flammable facesheets that provides useful data. For the most part, the flat panel and I-beam hybrid laminates performed as expected.

The observed behavior for a hybrid laminate starts with heat transfer through the inorganic composite into the flammable core. This in turn, will allow decomposition to occur. Because the facesheets are not intended primarily as insulators, the organic laminate may be subjected to its decomposition temperature in very little time. Therefore, the laminate facesheets primary purpose is to prevent oxygen from reaching the decomposition gases thereby preventing combustion from occurring. In this way the fireproof inorganic sheets eliminate one important parameter in the fire triangle: oxygen. Despite the transfer of heat through the fireproof laminate, the inorganic structure will retain a portion of its strength after the fire exposure.

Theoretically, a properly functioning hybrid laminate would increase the time required to completely decompose the organic laminate by eliminating oxygen. Decomposition will still take place; it will just require more time. The heat release data for a hybrid laminate has lower peak heat release rates. It is believed that this is due to the lack of oxygen available for combustion. If the theory holds that the fireproof inorganic resin acts as a fire and oxygen barrier, fireproof laminate thickness should have little effect on fire performance. Interestingly, the data did show a direct correlation between facesheet thickness in both the epoxy and the phenolic laminate hybrids and the times to ignition and heat release rates. The increase in insulation resulting from the laminate thickness could be the cause for this trend; however, this does not seem likely. Another possible explanation could be a laminate stiffness effect. A fireproof sheet with greater thickness would allow better attachment to the organic laminate, allowing the oxygen barrier to remain in place for a longer period.

The flat sheet hybrid laminates made with the epoxy core all used a high temperature adhesive for bonding the facesheet. The phenolic core hybrid laminate did not use an adhesive, but instead was bonded to the core's abraded surface during the curing of the inorganic resin. The data from both of these adhesive methods followed the same trends indicating that the bonding had little effect on the hybrid performance. The hybrid laminates made with epoxy core showed increases in time to ignition ranging from an increased factor of four for the 1 ply to a factor of ten for the 8 ply. Also the fireproof inorganic resin facesheets acting as an oxygen barrier resulted in decreases in both the heat release peak rate and rate at 5 minutes. The total heat releases for all the samples tested were approximately the same. The phenolic core hybrid laminates consisted of facesheets of 2 ply carbon and gave comparable results to the epoxy core hybrid laminate in both increasing time to ignition and decreasing heat release rates.

The second phase of this evaluation was to determine the effect of protecting an I-beam made from epoxy/glass and phenolic/glass with a fireproof inorganic laminate. The test method used in this evaluation was an actual small-scale fire test using an ASTM E-119 fire curve. The test was done first on an epoxy/glass I-beam that failed in 3 minutes into the E-119 fire curve. Hybrid epoxy I-beam failed 12.5 minute into the E-119 fire curve with the 20-pound weight hanging from the I-beam. The phenolic I-beam failed at 9 minute versus 19 minutes for the hybrid laminate coated I-beam. The laminate theoretically should prevent oxygen from being available for combustion and thus increase the time to failure for the hybrid I-beam. The improvement in time to failure for the 1-beams with a protective layer of fireproof inorganic resin showed that a thin layer, 0.03 inches thick, could have a substantial improvement in fire performance. Similar to the failure mode of the flat panels, I-beams eventually fail because of the decomposing effects of heat.

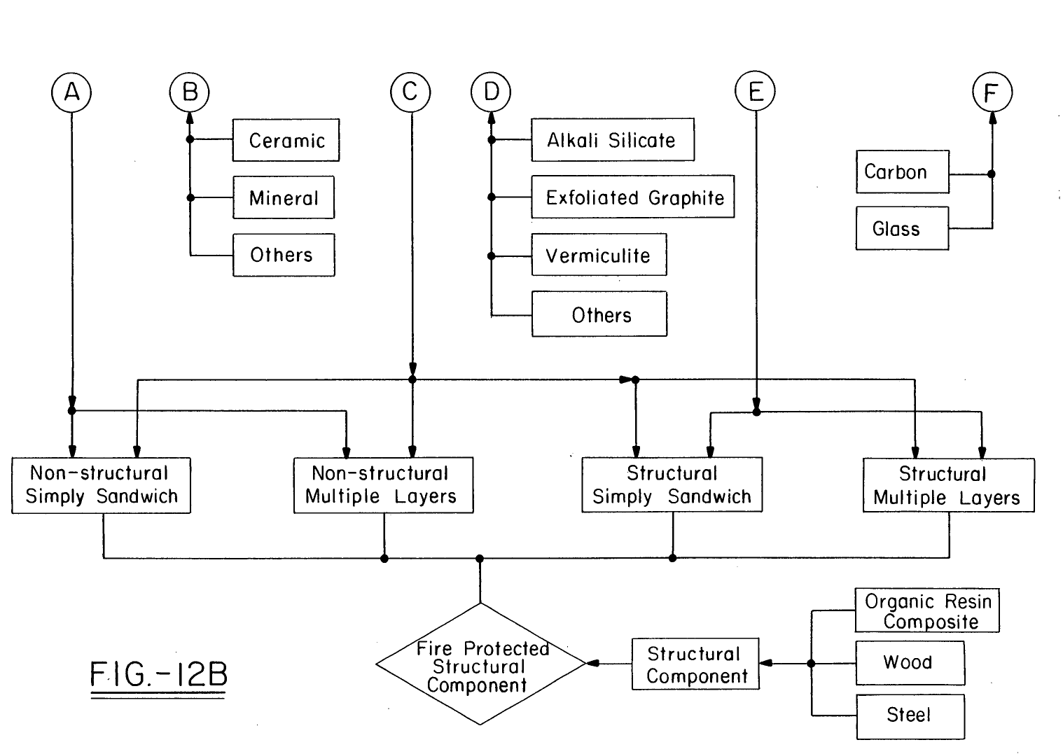

Other embodiments of the present invention are shown in FIG. 12. As shown at the top middle portion of FIG. 12, the alkali silicate resin can be reinforced with any suitable type of material such as glass reinforcement, or carbon reinforcement, or steel reinforcement to make a alkali silicate reinforced composite. The composite can be utilized as is to form a fire protected structural component, or be applied to various substrates such as an organic resin composite, wood, steel, etc., to form a structural component. Alternatively, the alkali silicate composite can form an insulation system by adding different types of insulation thereto such as ceramic, mineral, and the like. Alternatively, an intumescent system can be formed by adding various different types of intumescents such as an alkali silicate, an exfoliate graphite, vermiculite, etc., to the alkali silicate composite. Similarly, various different types of inorganic foams, such as glass or carbon, can be added to the alkali silicate composite to form a foam system. These systems as well as other systems, not shown, can be formed into different types of structures such as a simple sandwich, a multi-layer sandwich, etc. to form still other systems with the same then being applied to a substrate to form a fire protected structural system.

The substrate to be protected can generally be any type of material which is often esthetically pleasing but generally has a low burning point or ignition temperature. Common substrates include wood such as numerous types of hardwood, for example maple, oak, ash, etc., or soft wood such as various types of pines, etc., as well as plywood, laminated wood, and so forth. Other substrates include organic resins which generally encompass numerous types of polymers such as polyesters, polyethers, polyolefins, polyvinylchloride, epoxies, nylons, phenolics, and the like. Still other substrates include low melting point metals such as aluminum, brass, bronze, and even various types of steel. The two or more alkali silicate composites can be adjacent to one another or separated by another layer and the like.

As can be appreciated from the present invention, fire resistant and/or fire proof laminates or composites can be made from a variety of shapes and materials. The fire resistant alkali silicate resins of the present invention are flexible enough to be applied to various shapes whether they are structural objects or combinations which provide improved fire safety combined with esthetics, by using, for example, wood lamina.

According to another embodiment of the present invention, the various multi-layer fire barrier systems set forth hereinabove can be secured together by at least one fastener and the like. Typical fasteners include a bolt, staple, rivet, wire, adhesive, magnet, edge channel, screw, nail, or combinations thereof.

The foregoing embodiments of the present invention have been presented for the purposes of illustration and description. These descriptions and embodiments are not intended to be exhaustive or to limit the invention to the precise form disclosed, and obviously many modifications and variations are possible in light of the above disclosure. The embodiments were chosen and described in order to best explain the principle of the invention and its practical applications to thereby enable others skilled in the art to best utilize the invention in its various embodiments and with various modifications as are suited to the particular use contemplated. It is intended that the invention be defined by the following claims.

While in accordance with the Patent Statutes, the best mode and preferred embodiments have been set forth, the scope of the invention is not limited thereto, but rather by the scope of the attached claims.

1. A multi-layer fire-barrier system, comprising:
at least one layer of an alkali silicate resin composition comprising;
an inorganic resin composition comprising the reaction product of an alkali silicate and/or alkali silicate precursors, water, and optionally a clay and/or oxide filler; or
an inorganic resin composition comprising the reaction product of an alkali silicate and/or alkali silicate precursors, one or more acidic oxoanionic compounds, water, optionally one or more compounds containing multivalent cation(s) comprising Groups, 2, 3, 4, 5, 6, 7, 8, 9, 10, 11, 12, 13, 14, 15, or 16 of the periodic table or any combination thereof, and optionally a clay and/or oxide filler; or
an inorganic resin composition comprising the reaction product of an alkali silicate and/or alkali silicate precursors, a reaction glass, water, optionally one or more acidic oxoanionic compounds, and optionally a clay and/or oxide filler; and
at least one layer of any of an optional material comprising an insulation material, an intumescent material, a foam material, a reflective material, a reinforcing material, a corrugated material, any of the above materials containing a gas space therein, or any combination thereof.

2. A multi-layer fire-barrier system according to claim 1, wherein said alkali silicate resin layer contains a reinforcing material therein, and wherein said reinforcing material comprises at least one fiber, a sheet, a screen, or a mesh, or combinations thereof.

3. A multi-layer fire-barrier system according to claim 2, wherein said resin composition includes non-clay filler materials comprising fibers, spheres, and particles, and wherein said spheres comprise microspheres, macrospheres, or hollow spheres, and solid spheres comprising glass, ceramic, metal, mineral, organic, or inorganic materials

4. A multi-layer fire-barrier system according to claim 2, wherein reinforcing fiber comprises a nickel fiber, glass fiber, carbon fiber, graphite fiber, mineral fiber, oxidized carbon fiber, oxidized graphite fiber, oxidized polyacrylonitrile, fiber, steel fiber, metallic fiber, metal-coated carbon fiber, metal-coated glass fiber, metal-coated graphite fiber, metal-coated ceramic fiber, nickel-coated graphite fiber, nickel-coated carbon fiber, nickel-coated glass fiber, quartz fiber, ceramic fiber, silicon carbide fiber, stainless steel fiber, titanium fiber, nickel alloy fiber, brass-coated steel fiber, polymeric fiber, polymer-coated carbon fibers, polymer-coated graphite fiber, polymer-coated glass fiber, ceramic-coated carbon fiber, ceramic-coated graphite fiber, ceramic-coated glass fiber, aramid fiber, basalt fiber, alkaline resistant glass fiber, an E-glass fiber, S-glass fiber, basalt fiber, polyethylene fiber, SiC fiber, or BN fiber, or combinations thereof.

5. A multi-layer fire-barrier system according to claim 2, wherein said reinforcing fibers comprise a graphite fiber, E-glass fiber, S-glass fiber, basalt fiber, stainless steel fiber, titanium fiber, nickel alloy fiber, aramid fiber, oxidized polyacrylonitrile fiber, polyethylene fiber, SiC fiber, or BN fiber, and combinations thereof.

6. A multi-layer fire-barrier system according to claim 4, wherein said alkali silicate comprises a potassium silicate solution, a sodium silicate solution, crystalline sodium silicate, crystalline potassium silicate, amorphous sodium silicate, or amorphous potassium silicate, lithium silicate, and mixtures thereof,
wherein said reactive glass comprises a compound of the formula
a(A′₂O)ₓb(G_{f}O)_{y}c(A″O)_{z}
where A′ represents at least one alkali metal glass modifiers, which functions as a fluxing agent, G_{f} represents at least one glass formers, A″ represents, optionally, at least one glass network modifier, a represents the number of agents present and ranges from 1 to about 5, b represents the number of glass formers present and ranges from 1 to about 10, c represents the number of glass network modifiers and ranges from 0 to about 30, x represents the mole fraction of fluxing agent and is between about 0.050 and about 0.150, y represents the mole fraction of glass former and is between about 0.200 and about 0.950, z represents the mole fraction of glass network modifiers and is between 0.000 or about 0.001 and about 0.500, x+y+z=1, and x<y, wherein A′ comprises lithium, sodium, potassium, rubidium, or cesium, wherein Gf comprises boron, silicon, phosphorus, sulfur, germanium, arsenic, antimony, aluminum or vanadium, and wherein A″O is at least one metallic glass modifier and comprises vanadium oxide, titanium oxide, zinc oxide, lead oxide, aluminum oxide, zirconium oxide, lanthanum oxide, cerium oxide, neodymium oxide, magnesium oxide, calcium oxide, strontium oxide, barium oxide, or silicon oxide, or combinations thereof; and
wherein said acidic oxoanionic compound comprises boric acid, phosphoric acid, sulfuric acid, sodium dihydrogen phosphate, disodium hydrogen phosphate, dipotassium hydrogen phosphate, potassium dihydrogen phosphate, ammonium hydrogen phosphate, ammonium dihydrogen phosphate, metallic and/or nonmetallic phosphate salts or compounds incorporating borate, sulfate, alumiriate, vanadate, or germanate, or combinations thereof.

7. A multi-layer fire-barrier system according to claim 6, wherein said filler comprises at least one oxide comprising an oxide of boron, aluminum, silicon, zinc, gallium, titanium, zirconium, manganese, iron, molybdenum, tungsten, bismuth, lead, lanthanum, cerium, neodymium, yttrium, calcium, magnesium, or barium and is present in an amount of between 0.0 wt. % or about 0.01 wt. % and about 20 wt. % based upon the total composition weight, and wherein said clay filler comprises kaolin, calcined kaolin, mica, vermiculite and/or metakaolin and is present in an amount of between 0.0 wt. % or about 0.1 wt. % and about 20 wt. % based upon the total composition weight, and
wherein said cation is an alkaline earth or zinc cation.

8. A multi-layer fire-barrier system according to claim 6, wherein said resin composition comprises a reaction product of the following:
about 30 to about 85 wt. % of at least said alkali silicate;
about 0.01 to about 60 wt. % of at least said reactive glass;
about 0 or 0.01 to about 20 wt. % of at least said acidic oxoanionic compound;
0 or about 0.1 wt. % to about 20 wt. % of at least said clay filler;
0 or about 0.01 wt. % to about 20 wt. % of at least said oxide; and
about 15 to about 60 wt. % of said water.

9. A multi-layer barrier system according to claim 6, wherein said resin composition comprises a reaction product of the following:
about 30 to about 85 wt. % of at least said alkali silicate;
about 0.01 to about 20 wt. % of at least said multivalent cation(s) of Groups 2, 3, 4, 5, 6, 7, 8, 9, 10, 11, 12, 13, 14, 15 or 16 of the periodic table;
about 0.01 to about 20 wt. % of at least said acidic oxoanionic-compound;
0 or about 0.1 wt. % to about 20 wt. % of at least said clay filler;
0 or about 0.01 wt. % to about 20 wt. % of at least said oxide; and
about 15 to about 60 wt. % of said water.

10. A multi-layer fire-barrier system according to claim 8, wherein said resin composition is formed by curing the resin at a temperature ranging from about 15° C. to 1000° C., an external pressure from ambient to about 20,000 psi, and optionally under a vacuum of from about ambient to about 10⁻³ torr.

11. A multi-layer fire-barrier system according to claim 2, including at least one layer of said alkali silicate resin composition, and including said at least one insulation layer.

12. A multi-layer fire-barrier system according to claim 4, including at least one layer of said alkali silicate resin composition, and including said at least one insulation layer; and wherein said insulation comprises a silicate compound; alumina compound; alumina silicate compound; ceramic; metal oxide containing silica, silicate, alumina, or aluminate; or refractory material; or combinations thereof.

13. A multi-layer fire-barrier system according to claim 6, including at least one layer of said alkali silicate resin composition, and including said at least one insulation layer; and wherein said insulation comprises a silicate compound; alumina compound; alumina silicate compound; ceramic; metal oxide containing silica, silicate, alumina, or aluminate; or refractory material; or combinations thereof.

14. A multi-layer fire-barrier system according to claim 8, including at least one layer of said alkali silicate resin composition, and including said at least one insulation layer; and wherein said insulation comprises a silicate compound; alumina compound; alumina silicate compound; ceramic; metal oxide containing silica, silicate, alumina, or aluminate; or refractory material; or P1 combinations thereof.

15. A multi-layer fire-barrier system according to claim 11, including at least one intumescent layer.

16. A multi-layer fire-barrier system according to claim 12, including at least one intumescent layer.

17. A multi-layer fire-barrier system according to claim 13, including at least one intumescent layer, wherein said intumescent layer comprises exfoliated graphite, alkali silicate, alkaline earth silicate, vermiculite, or combinations thereof.

18. A multi-layer fire-barrier system according to claim 14, including at least one intumescent layer, wherein said intumescent layer comprises exfoliated graphite, alkali silicate, alkaline earth silicate, vermiculite, or combinations thereof.

19. A multi-layer fire-barrier system according to claim 2, including said at least one layer of said alkali silicate resin composition, and including said at least one intumescent layer.

20. A multi-layer fire-barrier system according to claim 5, including said at least one layer of said alkali silicate resin composition, and including said at least one intumescent layer.

21. A multi-layer fire-barrier system according to claim 6, including said at least one layer of said alkali silicate resin composition, and including said at least one intumescent layer, wherein said intumescent layer comprises exfoliated graphite, alkali silicate, alkaline earth silicate, vermiculite, or combinations thereof.

22. A multi-layer fire-barrier system according to claim 8, including said at least one layer of said alkali silicate resin composition, and including said at least one intumescent layer, wherein said intumescent layer comprises exfoliated graphite, alkali silicate, alkaline earth silicate, vermiculite, or combinations thereof.

23. A multi-layer fire-barrier system according to claim 19, wherein said system is a fire door comprising at least one exterior wood layer.

24. A multi-layer fire-barrier system according to claim 20, wherein said system is a fire door comprising at least one exterior wood layer, and wherein said system comprises at least said one intumescent layer and at least two said alkali silicate resin layers.

25. A multi-layer fire-barrier system according to claim 21, wherein said system is a fire door comprising at least one exterior wood layer, and wherein said system comprises at least two said intumescent layers and at least three said alkali silicate resin layers, and wherein at least one said alkali silicate resin layer contains a steel reinforcing mat.

26. A multi-layer fire-barrier system according to claim 22, wherein said system is a fire door comprising at least one exterior wood layer, and wherein said system comprises at least two said intumescent layers and at least three said alkali silicate resin layers, and wherein at least one said alkali silicate resin layer contains a steel reinforcing mat.

27. A multi-layer fire-barrier system according to claim 2, including at least one said reinforcing layer.

28. A multi-layer fire-barrier system according to claim 5, including at least two said reinforcing layers, said alkali silicate resin layer located between said two reinforcing layers.

29. A multi-layer fire-barrier system according to claim 6, including at least two said reinforcing layers, said alkali silicate resin layer located between said two reinforcing layers, and wherein said reinforcing layer is glass, glass fiber, graphite fiber, basalt fiber, stainless steel fiber, titanium fiber, nickel alloy fiber, aramid fiber, polyethylene fiber, oxidized polyacrylonitrile fiber, SiC fiber or BN fiber, or combinations thereof.

30. A multi-layer fire-barrier system according to claim 8, including at least two said reinforcing layers, said alkali silicate resin layer located between said two reinforcing layers, wherein said reinforcing layer is glass, glass fiber, graphite fiber, basalt fiber, stainless steel fiber, titanium fiber, nickel alloy fiber, aramid fiber, polyethylene fiber, oxidized polyacrylonitrile fiber, SiC fiber or BN fiber, or combinations thereof.

31. A multi-layer fire-barrier system, comprising;
at least two layers of an alkali silicate resin composition comprising the reaction product of an alkali silicate and/or alkali silicate precursors, one or more acidic oxoanionic compounds, water, optionally one or more compounds containing multivalent cation(s) selected from Groups 2, 3, 4, 5, 6, 7, 8, 9, 10, 11, 12, 13, 14, 15 or 16 of the periodic table, and optionally a clay and/or oxide filler; and combinations thereof;
at least one said alkali silicate resin layer containing a reinforcement compound therein; and
at least one layer of any of an optionally material comprising an insulating material, an intumescent material, a foam material, a reflective material, a reinforcing material, a corrugated material, any of the above materials containing a gas space therein, or any combination thereof.

32. A multi-layer fire-barrier system according to claim 31, wherein said reinforcing compound of said alkali silicate material is a fiber, or a plurality of different types of fibers, a sheet, a screen, or a mesh, or combinations thereof.

33. A multi-layer fire-barrier system according to claim 32, wherein reinforcing fiber comprises a nickel fiber, glass fiber, carbon fiber, graphite fiber, mineral fiber, oxidized carbon fiber, oxidized graphite fiber, oxidized polyacrylonitrile fiber, steel fiber, metallic fiber, metal-coated carbon fiber, metal-coated glass fiber, metal-coated graphite fiber, metal-coated ceramic fiber, nickel-coated graphite fiber, nickel-coated carbon fiber, nickel-coated glass fiber, quartz fiber, ceramic fiber, silicon carbide fiber, stainless steel fiber, titanium fiber, nickel alloy fiber, brass-coated steel fiber, polymeric fiber, polymer-coated carbon fibers, polymer-coated graphite fiber, polymer-coated glass fiber, ceramic-coated carbon fiber, ceramic-coated graphite fiber, ceramic-coated glass fiber, aramid fiber, basalt fiber, alkaline resistant glass fiber, an E-glass fiber, S-glass fiber, basalt fiber, polyethylene fiber, SiC fiber, or BN fiber, or combinations thereof.

34. A multi-layer fire-barrier system according to claim 33, wherein said alkali silicate comprises a potassium silicate solution, a sodium silicate solution, crystalline sodium silicate, crystalline potassium silicate, lithium silicate, amorphous sodium silicate, or amorphous potassium silicate, and mixtures thereof,
wherein said reactive glass comprises a compound of the formula
a(A′₂O)ₓb(G_{f}O)_{y}c(A′O)_{z}
where A′ represents at least one alkali metal glass modifiers, which functions as a fluxing agent, G_{f} represents at least one glass formers, A″ represents, optionally, at least one glass network modifier, a represents the number of fluxing agents present and ranges from 1 to 5, b represents the number of glass formers present and ranges from 1 to 10, c represents the number of glass network modifiers and ranges from 0 to about 30, x represents the mole fraction of fluxing agent and is between about 0.050 and about 0.150, y represents the mole fraction of glass former and is between about 0.200 and about 0.950, z represents the mole fraction of glass network modifiers and is between about 0.000 and about 0.500, x+y+z=1, and x<y, wherein A′ comprises lithium, sodium, potassium, rubidium, or cesium, wherein Gf comprises boron, silicon, phosphorus, sulfur, germanium, arsenic, antimony, aluminum or vanadium, and wherein A″O is at least one metallic glass modifier and comprises vanadium oxide, titanium oxide, zinc oxide, lead oxide, aluminum oxide, zirconium oxide, lanthanum oxide, cerium oxide, neodymium oxide, magnesium oxide, calcium oxide, strontium oxide, barium oxide, or silicon oxide, or combinations thereof; and
wherein said acidic oxoanionic compound comprises boric acid, phosphoric acid, sulfuric acid, sodium dihydrogen phosphate, disodium hydrogen phosphate, dipotassium hydrogen phosphate, potassium dihydrogen phosphate, ammonium hydrogen phosphate, ammonium dihydrogen phosphate, metallic and/or nonmetallic phosphate salts or compounds incorporating borate, sulfate, aluminate, vanadate, or germanate, or combinations thereof.

35. A multi-layer fire-barrier system according to claim 34, wherein said reinforcing fibers comprises a graphite fiber, E-glass fiber, S-glass fiber, basalt fiber, stainless steel fiber, titanium fiber, nickel alloy fiber, aramid fiber, polyethylene fiber, oxidized polyacrylonitrile fiber, SiC fiber, BN fiber, and combinations thereof, and
wherein said cation is an alkaline earth or a zinc cation.

36. A multi-layer fire-barrier system according to claim 35, wherein said resin composition comprises a reaction product of the following:
about 30 to about 85 wt. % of at least said alkali silicate;
about 0.01 to about 60 wt. % of at least said reactive glass;
about 0.01 to about 20 wt. % of at least said acidic oxoanionic compound;
0 or about 0.1 wt. % to about 20 wt. % of at least said clay filler;
0 or about 0.01 wt. % to about 20 wt. % of at least said oxide; and
about 15 to about 60 wt. % of said water.

37. A multi-layer fire-barrier system according to claim 35, wherein said resin composition comprises a reaction product of the following:
about 30 to about 85 wt. % of at least said alkali silicate;
about 0.01 to about 20 wt. % of at least said multivalent cation(s) of Groups 2, 3, 4, 5, 6, 7, 8, 9, 10, 11, 12, 13, 14, 15 or 16 of the periodic table;
about 0.01 to about 20 wt. % of at least said acidic oxoanionic compound;
0 or about 0.1 wt. % to about 20 wt. % of at least said clay filler;
0 or about 0.01 wt. % to about 20 wt. % of at least said oxide; and
about 15 to about 60 wt. % of said water.

38. A multi-layer fire-barrier system according to claim 31, wherein at least two of said alkali silicate resin layers are adjacent to each other; and
including at least one of said optional layers.

39. A multi-layer fire-barrier system according to claim 34, wherein at least two of said alkali silicate resin layers are adjacent to each other; and
including at least one of said optional layers.

40. A multi-layer fire-barrier system according to claim 36, wherein at least two of said alkali silicate resin layers are adjacent to each other; and
including at least two of said optional layers.

41. A multi-layer fire-barrier system according to claim 1, comprising at least two layers secured together by at least one fastener.

42. A multi-layer fire-barrier system according to claim 41, wherein said fastener comprises a bolt, staple, rivet, wire, adhesive, magnet, edge channel, screw, or nail, or combinations thereof.
